(19) United States
(12) Patent Application Publication
(10) Pub. No.: US 2004/0044724 A1
(43) Pub. Date: Mar. 4, 2004

(54) Apparatus and methods to exchange menu information among processor-based devices

(76) Inventors: Cynthia S. Bell, Chandler, AZ (US); Nathan Y. Smith, Scottsdale, AZ (US); Michael S. Fox, Chandler, AZ (US); Malcolm D. MacNiven, Phoenix, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/228,829

(22) Filed: Aug. 27, 2002

(51) Int. Cl. G06F 15/16

(52) U.S. Cl. 709/203

(57) ABSTRACT

A first type of processor-based device, such as a personal computer functioning as a host and containing digital media files, may wirelessly communicate with a second type of processor-based device, such as a digital picture frame (DPF). Upon request and/or upon the occurrence of certain conditions, the host may transmit menu and/or media file choices to the DPF. Responsive to user choices entered at the DPF and transmitted to the host, the host may transmit further menu choices and/or media files to the DPF. In one embodiment, the menu choices displayed on the DPF reflect a DPF file hierarchy that is identical to that of the host. An electronic appliance and a machine-accessible medium are also described.

### RELATED APPLICATIONS

The present application is related to the following applications, which were assigned to the same assignee as the present application and filed on even date herewith:

(1) Ser. No. ______, entitled “User Interface to Facilitate Media File Exchange Among Processor-Based Devices” (Attorney Docket 884.744);

(2) Ser. No. ______, entitled “Network of Disparate Processor-Based Devices to Exchange and Display Media Files” (Attorney Docket 884.746); and

(3) Ser. No. ______, entitled “Apparatus and Methods to Select and Access Displayed Objects” (Attorney Docket 884.747).

### TECHNICAL FIELD

Embodiments of the present invention relate generally to the storage and display of digital media and, more particularly, to apparatus and methods to exchange menu information between processor-based devices, such as a host computer and an electronic appliance.

### BACKGROUND INFORMATION

A wide spectrum of processor-based devices, such as personal computers (PCs), personal digital assistants (PDAs), electronic appliances, digital picture frames (DPFs), chat pads, palm-top computers, Internet cell phones and pagers, MP3 (Moving Picture Experts Group, audio layer 3) audio players, and many others, are popular with consumers today. The category names distinguishing different types of processor-based devices, and the lines of distinction between them, are becoming increasingly blurred.

Many of these devices can communicate not only with devices of like or similar type, but they can also communicate with devices having substantially greater or lesser resources. Some devices communicate directly with identical devices or with a host or base station via a dedicated cable or wireless link. Others may communicate via a communications network, which may range in size and complexity from a very small local network (e.g. a host PC interacting with a palm-top computer; an in-home or in-building network; etc.) to global networks like the Internet and the World-Wide Web (“WWW”).

Digital media files of many types, including pictures, video, audio, greeting cards, animations, games, artwork, music compositions, x-rays, scanned documents, software programs, instant messages, and the like are frequently transmitted between computing devices.

In a variety of known examples, one processor-based device functioning as a host may communicate wirelessly or via a cable with a less fully featured processor-based device, which may be referred to herein as a “processor-based appliance”, a “digital appliance”, an “electronic appliance”, or simply an “appliance”. An example is a chat pad wirelessly communicating with a PC. Another example is a processor-based telephone communicating telephone call information with a processor-based device that acts as a host. Other examples include a PDA or a digital music player that may wirelessly communicate with a PC.

It is known that a PDA may be synchronized with a host PC by plugging the PDA into a docking cradle. In such case, files on both the PDA and the PC are synchronized. By “synchronized” is meant that any relevant file on one system is loaded onto the other and vice versa. Thus, when the systems are separated, both the PDA and the PC have all the same relevant files. Thus, the PDA may operate somewhat autonomously from the PC.

While this synchronization technique may be useful when a physical connection (e.g. a cable) is provided between the two devices, in wireless applications such an approach may be less than optimal. For example, the available wireless bandwidth may be sufficiently limited that sharing all relevant files between two devices may be impractical, time-consuming or excessively power-consuming. Further, the expectations of the user change when devices are in wireless communication. They often expect that the both devices are always synchronized and that synchronization happens as an automatic background task.

Moreover, known synchronization techniques merely ensure that a PC and a PDA contain identical copies of relevant files. There is no provision for storing the files in the PDA in a file hierarchy that is identical to all or a portion of the file hierarchy of the PC host. Thus, for a PDA user to locate and use a particular file may require a substantial amount of user involvement and tedious searching. These operations may be sufficiently tedious that they may significantly decrease the user's enjoyment and utilization of the processor-based appliance.

Many electronic appliances, such as VCRs, cell phones, PDAs and DPFs, are known to use fixed menus. Such menus are static, and the features they offer are usually not modifiable once they leave the factory. For example, the native language and fonts in the graphical user interface (GUI) are typically set in firmware. The manufacturer must “localize” the firmware for different geographic regions. Similarly, the menus for applications and file access are prestructured. While new applications and files can be downloaded manually, they must conform to the existing appliance infrastructure defined at the factory. Thus, electronic appliances are not able to adapt to dynamic, multi-tiered digital media content file hierarchies created in a host PC, making it difficult for the appliance user to store and retrieve files, such as images or albums stored within the host PC file system.

Thus, there is a need for better ways to share menu information between a host and an electronic appliance.

### BRIEF DESCRIPTION OF THE DRAWINGS

FIG. 1 is a perspective view of equipment, including a processor-based device such as a digital picture frame, and a host computer, to implement one or more embodiments of the present invention;

FIG. 2 is a block diagram of a processor-based appliance in accordance with an embodiment of the present invention;

FIG. 3 is a block diagram of a wireless remote control element shown in FIG. 1, in accordance with an embodiment of the present invention;

FIG. 4 is a block diagram of a host computer that is coupled to a local network and/or a wide-area network, and that implements one or more embodiments of the present invention;

FIG. 5 illustrates a depiction of a menu of a graphical user interface (GUI) displayed on a display of a processor-based appliance, in accordance with an embodiment of the present invention;

FIG. 6 illustrates a depiction of sub-menus within the “Pets” folder of the GUI illustrated in FIG. 5;

FIG. 7 illustrates a depiction of sub-menus within the “Webcam” folder of the GUI illustrated in FIG. 5;

FIG. 8 is a communications diagram showing a communications sequence between a processor-based appliance and a host, in accordance with an embodiment of the present invention;

FIG. 9 is a flow diagram illustrating an exemplary method to select a menu item on a processor-based appliance, in accordance with an embodiment of the present invention;

FIG. 10 is a flow diagram illustrating an exemplary method for a host to respond to a request from a processor-based appliance, in accordance with an embodiment of the present invention;

FIG. 11 is a flow diagram illustrating an exemplary method for a host to provide support to and/or to update a processor-based appliance, in accordance with an embodiment of the present invention;

FIGS. 12A and 12B together constitute a combined flow diagram and communications diagram illustrating an exemplary method for a host to update a processor-based appliance, in accordance with an embodiment of the present invention;

FIGS. 13A and 13B together constitute a combined flow diagram illustrating an exemplary method for a host to power up, in accordance with an embodiment of the present invention;

FIG. 14 is a flow diagram illustrating an exemplary method for a processor-based appliance to power up, in accordance with an embodiment of the present invention;

FIG. 15 is a flow diagram illustrating an exemplary method for a host to synchronize with a processor-based appliance, in accordance with an embodiment of the present invention;

FIG. 16 is a flow diagram illustrating an exemplary method for a host to poll one or more processor-based appliances, in accordance with an embodiment of the present invention;

FIG. 17 is a block diagram of a network comprising a host and one or more processor-based devices or appliances, in accordance with one embodiment of the present invention;

FIG. 18 is a flow diagram illustrating an exemplary method for an appliance to obtain menu information from a host, in accordance with an embodiment of the present invention;

FIG. 19 shows an example of a template for a menu that provides selections for digital media content;

FIG. 20 depicts an example of a root menu template;

FIG. 21 depicts an example of a root menu populated with menu items;

FIG. 22 illustrates a depiction of a plurality of folders of a graphical user interface displayed on a display of a processor-based appliance, in accordance with an embodiment of the present invention;

FIG. 23 illustrates a depiction of a plurality of menus within a content folder of a graphical user interface;

FIG. 24 illustrates a depiction of a plurality of sub-folders of a graphical user interface;

FIG. 25 illustrates a depiction of a plurality of media file thumbnails within a sub-folder of a graphical user interface; and

FIG. 26 is a flow diagram illustrating an exemplary method for a host computer to generate menu information, in accordance with an embodiment of the present invention.

### DETAILED DESCRIPTION OF EMBODIMENTS OF THE INVENTION

In the following detailed description of embodiments of the invention, reference is made to the accompanying drawings that form a part hereof, and in which is shown by way of illustration, but not of limitation, specific embodiments of the invention. These embodiments are described in sufficient detail to enable those skilled in the art to understand and implement them, and it is to be understood that other embodiments may be utilized and that mechanical, structural, logical, electrical, and procedural changes may be made without departing from the spirit and scope of the present disclosure. The following detailed description is, therefore, not to be taken in a limiting sense, and the scope of embodiments of the present invention is defined only by the appended claims.

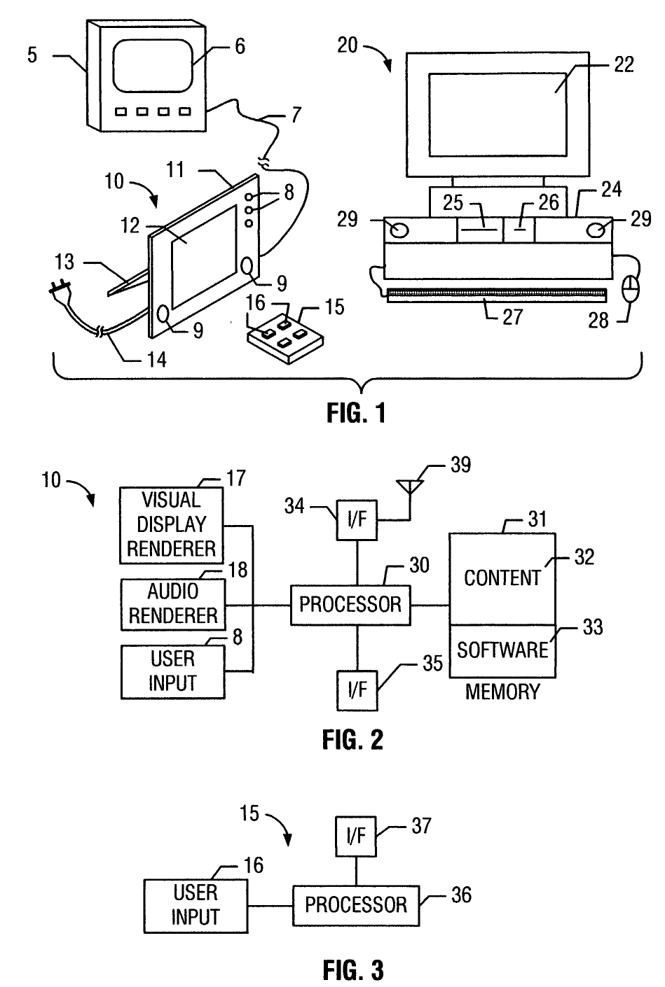

FIG. 1 is a perspective view of equipment, including a processor-based device such as a digital picture frame 10, and a host computer 20, to implement one or more embodiments of the present invention. Processor-based appliance 10 and host computer 20 and are both examples of processor-based devices.

The computing equipment shown in FIG. 1 is merely one example in which embodiments of the present invention can be used. In one example, a digital media file can be routed from a host computer 20 to a DPF 10 or other processor-based device. Elsewhere in the “Detailed Description of Embodiments of the Invention” is described how a digital media file may be routed from a host computer to another host computer.

Host computer (also referred to herein simply as “host”) 20 may be or include a personal computer 24. Host 20 may include a screen or display 22 in accordance with one embodiment. Host 20 may include one or more removable media slots, such as floppy disk slot 25 and memory card slot 26. Host 20 may also include a keyboard 27, a pointing device such as mouse 28, and/or any other element that permits an appliance user to input information into and receive information from host 20. Host 20 may include one or more loudspeakers 29.

Processor-based appliance 10 comprises a housing 11 and an optional screen or display 12. Display 12 displays any type of visually perceivable images, including text, graphics, and still or moving pictures. Processor-based appliance 10, in one embodiment, can optionally be coupled via a wire or cable 7 to an auxiliary display 5 having a screen or display 6, and having other user interface elements, such as controls, loudspeakers, and so forth. Auxiliary display 5 could be a television, computer monitor, or any other equipment that is suitable to render visual and/or audio media. In one embodiment, auxiliary display 5 is used with a low-cost processor-based appliance 10 that has no display 12. In another embodiment, auxiliary display 5 can provide features not provided on the processor-based appliance 10. For example, auxiliary display 5 can be a large-screen TV or high-definition TV.

Processor-based appliance 10 comprises suitable human interface elements with which an appliance user can input information into processor-based appliance 10 and receive information from processor-based appliance 10.

“Suitable”, as used herein, means having characteristics that are sufficient to produce the desired result(s). Suitability for the intended purpose can be determined by one of ordinary skill in the art using only routine experimentation.

Thus, processor-based appliance 10 can comprise one or more controls 8. Alternatively, on-screen touch-sensitive buttons (not shown) could be used. In one embodiment, appliance 10 is controlled by a wireless remote control 15 having one or more control buttons 16. Appliance 10 can include one or more loudspeakers 9.

Processor-based appliance 10, in one embodiment, is optionally supported in an upright configuration by a stand 13. Processor-based appliance 10 may be coupled to a suitable wall power outlet by a power cord 14; alternatively, processor-based appliance 10 could be operated using battery-supplied power.

Processor-based appliance 10, in the embodiment shown in FIG. 1, communicates wirelessly and bi-directionally with host 20; however, in other embodiments, processor-based appliance 10 could be coupled via wire or cable to host 20.

In one embodiment, host 20 communicates with processor-based appliance 10 using radio frequency signals, for example, in accordance with the Bluetooth specification (Specification of the Bluetooth System, Version 1.1, Feb. 22, 2001), the 802.11 specification (IEEE Standard 802.11 available from the Institute of Electrical and Electronics Engineers, New York, N.Y.), a Wireless Fidelity (“Wi-Fi”) protocol, or the like. Similarly, the remote control 15 may use any available wireless protocol to communicate with processor-based appliance 10. The communication may be made via a suitable infrared protocol. Typically, processor-based appliance 10 communicates with host 20 via a high bandwidth communications link, whereas processor-based appliance 10 communicates with remote control 15 using a low bandwidth link.

By using wireless communications between host 20 and processor-based appliance 10, a user of processor-based appliance 10 can conveniently roam within a reasonable distance of host 20, e.g. within the user's home.

In one embodiment, host 20 and processor-based appliance 10 are each assigned a unique 48-bit identifier (ID) to uniquely identify them. Host 20 and processor-based appliance 10 can communicate with each other by transmitting packets, using a suitable protocol. Alternatively, they could communicate in any other suitable manner.

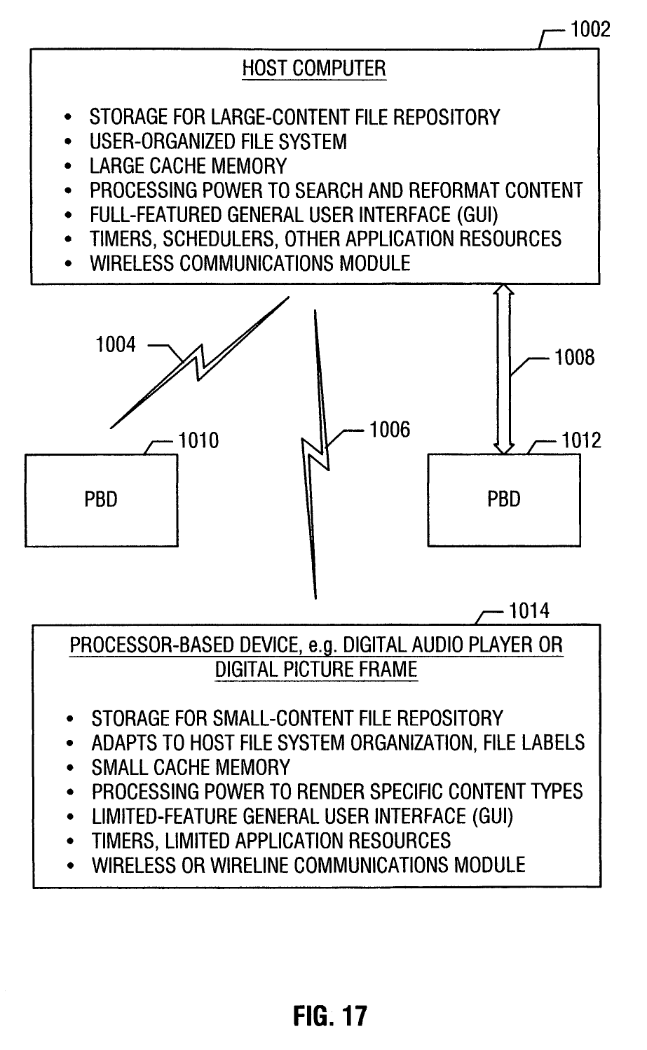

Other types of computing devices could be substituted for host 20. Such devices may take the form of a laptop or hand-held computer, for example. The substantive difference between host 20 and processor-based appliance 10 is primarily one of relative computational resources, as will be explained in greater detail regarding FIG. 17 below. In general, host 20 tends to have greater memory and/or processing resources than processor-based appliance 10.

Other types of processor-based devices or appliances 10 could be substituted for the DPF illustrated in FIG. 1. Without limitation, such alternative processor-based appliances 10 could include any device that can play back visual and/or audio information. For example, such a device may take the form of an Internet appliance, a hand-held computer, a laptop computer, a wireless communications device (e.g., cellular phone, 2-way pager, etc.), a personal entertainment device (e.g. a radio), audio-visual equipment, a personal digital assistant, an electronic book, and the like.

In accordance with one embodiment of the present invention, the host 20 may store a large number of digital pictures. These pictures may be transmitted under certain conditions to the processor-based appliance 10 for display on the display 12. In some embodiments, the display 12 displays, for variable periods of time, various pictures creating a digital slideshow on the DPF. In some cases, the pictures that are displayed on the display 12 are automatically varied with time of day and day of year or other change criteria. Thus, the picture display 12 of the processor-based appliance 10 may be periodically varied and updated to display a variety of images.

In accordance with one embodiment of the present invention, a gallery of digital pictures is provided at periodic intervals to the processor-based appliance 10. In one embodiment, a predetermined number (e.g., 40) of digital pictures may be provided each day over a wireless link to the processor-based appliance 10. The processor-based appliance 10 may then store those pictures in its memory (e.g. memory 31, FIG. 2) and may make those pictures available for display on the display 12, or the processor-based appliance 10 may automatically successively display those pictures in a slide show. In the next periodic interval, the pictures that are stored on the processor-based appliance memory may be overwritten or, if the memory capacity is sufficient, new pictures may be stored in addition to the previous interval's pictures.

However, rather than store the entire library of available pictures on the processor-based appliance 10, it may be advantageous in some embodiments to maintain the bulk of the available picture gallery on the host 20. This enables the processor-based appliance 10 to carry less storage capacity, decreasing costs in some embodiments. In addition, the need to wirelessly communicate a large amount of data between the host 20 and the processor-based appliance 10 may be reduced.

FIG. 2 is a block diagram of a processor-based appliance 10 in accordance with an embodiment of the present invention. The block diagram of FIG. 2 represents just one exemplary embodiment of a processor-based appliance 10. In this example, processor-based appliance 10 comprises a DPF. Processor-based appliance 10 comprises a suitable processor 30.

As used herein, “processor” means any type of computational circuit such as, but not limited to, a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), or any other type of processor or processing circuit. The term also includes embedded controllers, such as Generic or Programmable Logic Devices or Arrays, Application Specific Integrated Circuits, single-chip computers, and the like.

A visual display renderer 17, which can include all suitable circuitry for converting digital information into human-perceivable visual form, is coupled to processor 30. An optional sound reproduction element or audio renderer 18, which can include all suitable circuitry for converting digital information into human-perceivable audio form, is also coupled to processor 30. A suitable user input element 8, such as one or more control knobs, on-screen touch-sensitive buttons, or the like is also coupled to processor 30.

A first interface (I/F) 34, having an antenna 39, is coupled to processor 30. I/F 34 is used to interface processor-based appliance 10 wirelessly with a suitable wireless interface (not shown) of host 20.

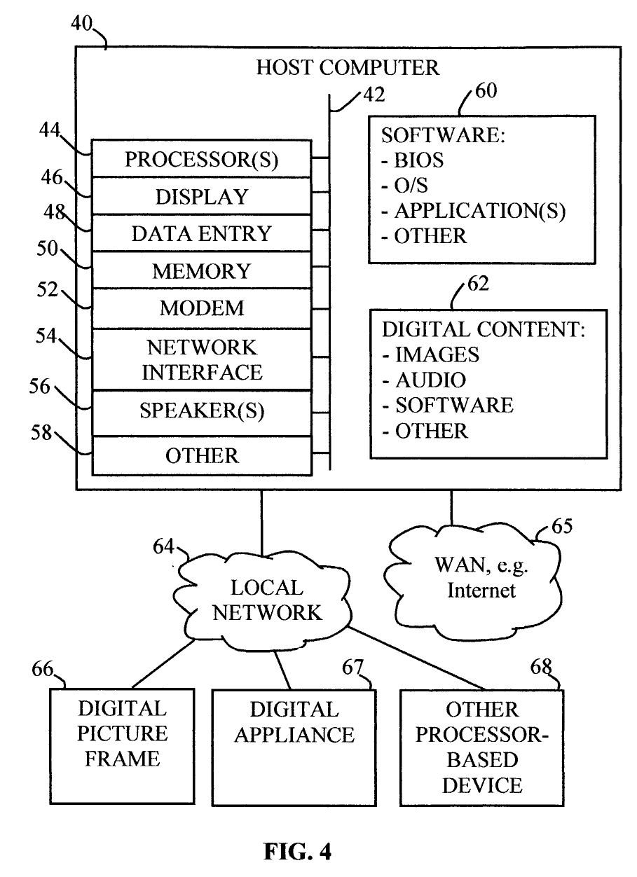

A second interface (I/F) 35 is coupled to processor 30. I/F 35 is used to interface processor-based appliance 10 wirelessly to remote control 15 (refer to FIG. 1 or 3).

Still referring to FIG. 2, a memory 31 is coupled to processor 30. Memory 31 can be any suitable memory device(s) like read only memory (ROM); random access memory (RAM); hard drive; removable media drive for handling compact disks (CDs), digital video disks (DVDs), diskettes, magnetic tape cartridges, memory cards, MemoryStick™ devices, SmartMediam™ devices, and other types of data storage; or the like.

Memory 31 can comprise digital content 32 and software 33. Content 32 can include images (both still and moving), text, audio, and any other types of digital content.

Software 33 can include one or more suitable software programs. For example, software 33 can include suitable operating system (O/S) software, one or more software applications, and any other types of software as required to perform the operational requirements of processor-based appliance 10.

FIG. 3 is a block diagram of a wireless remote control 15 shown in FIG. 1, in accordance with an embodiment of the present invention. The remote control 15 may comprise a processor 36 to control its operation.

Remote control 15 further comprises an interface (I/F) 37 that is coupled to processor 36. I/F 37 communicates with I/F 35 of processor-based appliance 10 (refer to FIG. 2).

Still referring to FIG. 3, remote control 15 further comprises a suitable user input 16, e.g. in the form of one or more control buttons (refer to FIG. 1).

FIG. 4 is a block diagram of a host computer 40 that is coupled to a local network 64 and/or a wide-area network 65, and that implements one or more embodiments of the present invention. Host 40 can be similar to or identical to host 20 illustrated in FIG. 1.

FIG. 4 and the following discussion provide a brief, general description of a suitable computing environment in which certain embodiments of the present invention may be implemented.

Thus, an exemplary host 40 comprises a computing device, a computing machine, a data processing system, or the like. Host 40 is merely one example of a computing system with which embodiments of the present invention can be used.

Host 40 comprises a system bus 42 to couple the various components of the system. System bus 42 provides communications links among the various components of host 40 and can be implemented as a single bus, as a combination of busses, or in any other suitable manner.

Coupled to bus 42 are typically one or more processors 44, a screen or display 46, and one or more data entry elements 48 such as a keyboard, mouse, trackball, joy stick, touch-sensitive screen, or the like.

Also coupled to bus 42 is a memory 50, which can include any suitable memory device(s) like read only memory (ROM); random access memory (RAM); hard drive; removable media drive for handling compact disks (CDs), digital video disks (DVDs), diskettes, magnetic tape cartridges, memory cards, MemoryStick™ devices, SmartMedia™ devices, and other types of data storage; or the like.

Additional elements may also be coupled to bus 42 such as a modem 52, a network interface unit 54, one or more loudspeakers 56, and other suitable devices 58.

Host 40 can also include a plurality of types of software programs. For example, host 40 can comprise software 60 that includes a basic input/output system (BIOS), operating system (O/S) software, one or more software applications, and any other types of software as required to perform the operational requirements of host 40.

Host 40 can also include a plurality of types of digital content 62. For example, host 40 can comprise digital content 62 that includes images (both still and moving), text, audio, computer software, and any other types of digital content.

Host 40 can operate in a networked environment using physical and/or logical connections to local network 64 and/or wide area network (WAN) 65. The connections to these networks can be wired and/or wireless.

Local network 64 can comprise any number or type of computing devices, such as a DPF 66, digital appliance 67, or any other processor-based device 68 such as those mentioned elsewhere herein.

WAN 65 can be any type of network that is greater in scope than local network 64. In one embodiment, WAN 65 comprises a global communications network, such as the Internet. In another embodiment, WAN 65 could comprise an intranet.

Embodiments of the invention may be implemented in conjunction with program modules, including functions, procedures, data structures, application programs, etc. for performing tasks, or defining abstract data types or low-level hardware contexts. Program modules may be stored in memory 50 and associated storage media, e.g., hard drives, floppy disks, optical storage, magnetic cassettes, tapes, flash memory cards, MemoryStick™ devices, SmartMedia™ devices, digital video disks, chemical storage, and/or biological storage. Program modules may be delivered over transmission environments, including networks 64 and 65, in the form of packets, serial data, parallel data, propagated signals, or any other suitable form. Program modules may be used in a compressed or encrypted format, and they may be used in a distributed environment and stored in local and/or remote memory, for access by single and multi-processor machines, or any other type of host 40.

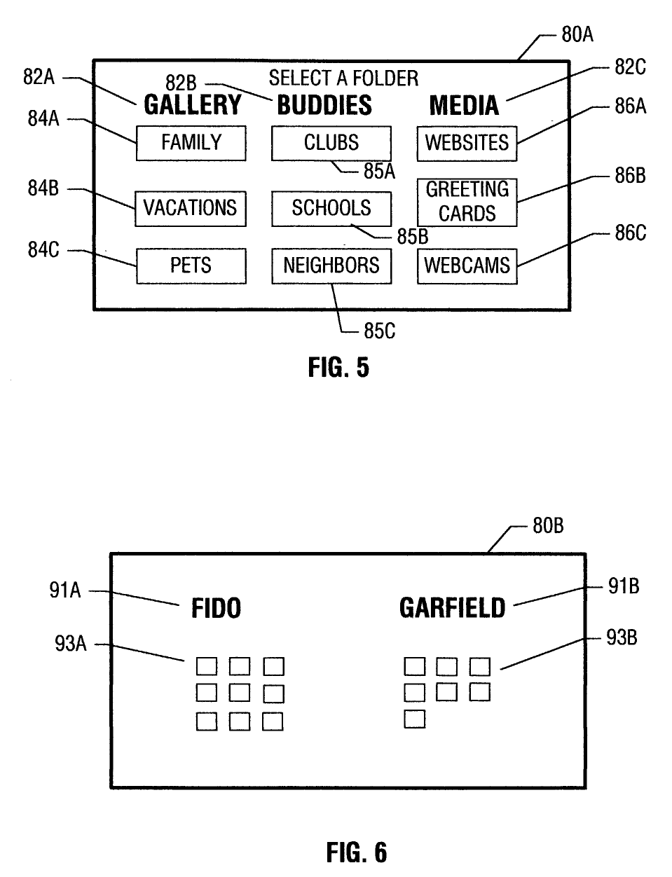

FIG. 5 illustrates a depiction of a menu 80 of a graphical user interface (GUI) displayed on a display of a processor-based appliance, in accordance with an embodiment of the present invention.

In accordance with one embodiment of the present invention, host 20 (FIG. 1) may serve as a convenient repository to store a large number of digital pictures or other digital media files. These digital media files may be transmitted or otherwise sent to the processor-based appliance 10 for display on the display 12 and/or auxiliary display 5 and/or for output from loudspeakers 9. In some embodiments, the display 12 and/or auxiliary display 5 displays, for variable periods of time, various pictures. In some cases, the pictures that are displayed on the displays 5 and/or 12 are automatically varied. Thus, the picture display 12 of the processor-based appliance 10 and/or auxiliary display 5 may be periodically varied and updated to display a variety of images.

In accordance with one embodiment of the present invention, a collection or “gallery” of digital pictures is provided at periodic intervals to the processor-based appliance 10. The gallery can be stored on the host 20. In one embodiment, a predetermined number (e.g., 40) of digital pictures may be provided over a wireless link to the processor-based appliance 10. The processor-based appliance 10 may then store those pictures in its memory 31 (FIG. 2) and may automatically display those pictures sequentially at full screen resolution on the display 12 (FIG. 1). The processor-based appliance 10 may automatically successively display those pictures in a slide show. In the next periodic interval, the pictures that are stored in the memory 31 may be overwritten or, if the capacity of memory 31 (FIG. 2) is sufficient, they may be stored in addition to the previous interval's pictures.

Rather than store the entire library of available pictures on the processor-based appliance 10 (FIG. 1), it may be advantageous in some embodiments to maintain the bulk of the available picture gallery on the host 20. This enables the processor-based appliance 10 to carry less storage capacity, decreasing costs in some embodiments. In addition, the need to wirelessly communicate a large amount of data between the host 20 and the processor-based appliance 10 may be distributed over time and as a background task while the system user enjoys the rendered data.

Thus, in accordance with one embodiment of the present invention, the available digital media content on the host 20 may have been grouped by the system user into a hierarchical structure. The levels of hierarchy may be titled. Thus, each level of a plurality of hierarchical levels may have an appropriate name or identifier. It is common for consumers to organize their personal media content collections when stored on a computing system. For example, personal digital images may be grouped by chronological or activity titles, while personal music collections may be grouped by musical genre or by artist.

Thus, the available digital media content is frequently organized in a multi-level file structure or hierarchy. The particular labels or names given to various levels in the file structure or menu structure have been chosen by the system user and have meaning to them.

In an exemplary embodiment, in order to simplify the management, including storage and retrieval, of digital media files for the appliance user, the menu hierarchy of the appliance 10 (FIG. 1), such as a DPF, can be substantially identical to that of host 20.

In one embodiment, the file structure of an appliance is a subset of the file structure of a host, and the hierarchy of this subset is substantially identical to a portion of the file structure hierarchy of the host.

Thus, the particular way a appliance user likes to arrange his or her digital files on host 20 can be mirrored on the appliance user's appliance 10, simplifying file management and increasing the utility and user-friendliness of the appliance 10. Because the number of levels in a hierarchy will vary from consumer to consumer, the infrastructure devised for the appliance is adaptive. The names given to the hierarchy levels on the host are presented in menus that follow the hierarchical order on the host.

“Menu”, as used herein, means a choice presented visually, audibly, and/or tactilely to an appliance user. The term “display”, as used herein, means rendering in any one or more human-perceivable forms. A menu can comprise one or more menu items, either at the same hierarchical level, or at different hierarchical levels. For example, a menu could comprise two menu items or choices. If desired, each menu item could comprise one or more sub-menu items. Each sub-menu item could comprise sub-sub-menu items, and so forth, in as wide and/or as deep a hierarchy as desired.

“Sub-menu”, as used herein, means a choice of selection lower than a menu item in a menu hierarchy. The particular name (e.g. “category”, “folder”, “menu item”, “sub-menu item”, “terminal item”, etc.) that is given to an item at any level of a menu hierarchy is very flexible and is not limited to the examples given herein.

In the embodiment shown in FIG. 5, a three-level hierarchy is depicted. Menu selections at the highest level of the hierarchy may be called “categories”. In the example shown in FIG. 5, the category level comprises “Gallery” 82A, “Buddies” 82B, and “Media” 82C.

The category of Gallery 82A depicts three menu items called “folders”, in the form of “Family” 84A, “Vacations” 84B, and “Pets” 84C. In one embodiment, Gallery 82A comprises pictorial items that are stored on host 20 (FIG. 1).

Still referring to FIG. 5, the category of Buddies 82B also depicts three menu items, namely “Clubs” 85A, “Schools” 85B, and “Neighbors” 85C. In one embodiment, the “Buddy” category 82B can list groups of people to whom the appliance user may send digital images electronically. The list of potential addressees (called “Buddies” in this example) may be broken into a hierarchy that includes sublevels. At the lowest level, buddies comprise Internet account addresses for the named individuals. This digital address book may contain account addresses for instant messaging, e-mail and other Internet account types to facilitate sharing from the appliance.

The category of Media 82C depicts three menu items, namely “Websites” 86A, “Greeting Cards” 86B, and “Webcams” 86A. The category of Media 82C may include digital media sources outside the processor-based appliance 10 and host 20 (FIG. 1) from which digital media (in one embodiment) may be obtained. Each of the Media 82C items may be associated with a particular media type, so that when the particular entries 86A-86C are selected by the appliance user, the host 20 (FIG. 1) is caused to list available content from the respective digital media sources.

As an example, if the user has a DVD jukebox on his or her host system, the movie titles would appear in the menu list. In some cases, digital media items may be associated with a particular Web site. For example, one media type may be a video clip, and one sub-menu item may be a current news Web site. When this menu item is selected, the host can access an associated Web site to retrieve the current video clip and then relays it to the appliance for viewing.

Still referring to FIG. 5, regarding the categories 81A-82C, each time one level is selected, the next lower sublevel listings may be displayed. As an example, an appliance user may select a folder from the menu of folders 84A-84C listed under the category “Gallery” 82A. In doing so, one or more sub-menu items within such folder will be visually and/or audibly presented to the user, as will now be explained with reference to FIG. 6.

FIG. 6 illustrates a depiction of sub-menus within the “Pets” folder 84C of the GUI illustrated in FIG. 5.

The contents of the “Pets” folder 84C are displayed to the appliance user. This includes a heading “Fido” 91A and another heading “Garfield” 91B.

Under “Fido” 91A is displayed a portion of the collection 93A of photo thumbnail images of the family dog. A “thumbnail image” is a miniature version of an image that can be used for quick browsing through a plurality of images.

Under “Garfield” 91B is displayed a portion of the collection 93B of photo thumbnail images of the family cat. The user may choose to view all of the images in this group as a slideshow. The user may also choose to view any single image from the group.

The photo thumbnail collections 93A and 93B may be particularly useful in cases where the appliance user does not bother to enter specific names for his or her digital images, but instead the particular images are identified only by the nomenclature supplied by a digital camera in the course of taking a digital photograph, or supplied by a film processor of non-digital photographs. Such nomenclature normally may consist of only a number.

By selecting one image of the photo thumbnail collections 93A or 93B, it will be displayed on the display of the processor-based appliance immediately.

In another embodiment, the files represented by photo thumbnail collections 93A and 93B could be any other type of digital media, such as audio or video files.

Although a 3-level display of menu hierarchy items has been shown and described, in other embodiments more or fewer levels could be used. The appropriate number of menu levels to display will vary with the display size and resolution, selected fonts, and other appliance variables. The number of levels in the overall menu system can conform to match that established by the user on the host.

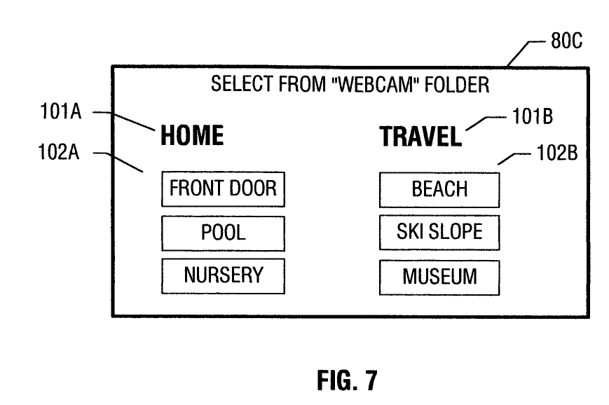

FIG. 7 illustrates a depiction of sub-menus within the “Webcam” folder 86C of the GUI illustrated in FIG. 5. For example, Webcam folder 86C comprises a “Home” heading 101A and a “Travel” heading 101B. Under the Home heading 101A are listed various sub-menu items 102A, such as “Front Door”, “Pool”, and “Nursery”. Under the Travel heading 101B are listed other sub-menu items 102B, such as “Beach”, “Ski Slope”, and “Museum”.

Also, Web sites such as those having Webcams may provide periodically updated images. In such case, whenever the appliance user selects a particular source, that source may then be accessed for new available image files. Those image files may then be downloaded to the host 20 and ultimately transferred to the processor-based appliance 10. The access may be automatically periodically performed in one embodiment.

The benefits to users for Webcams are the periodically occurring image updates conveying the passage of time throughout the day and the ability to have a virtual window on another place in the world, such as a beach or ski resort Webcam. The user may select one of these digital media sources from the menu and then enjoy watching the images of that locale on his or her DPF throughout the day.

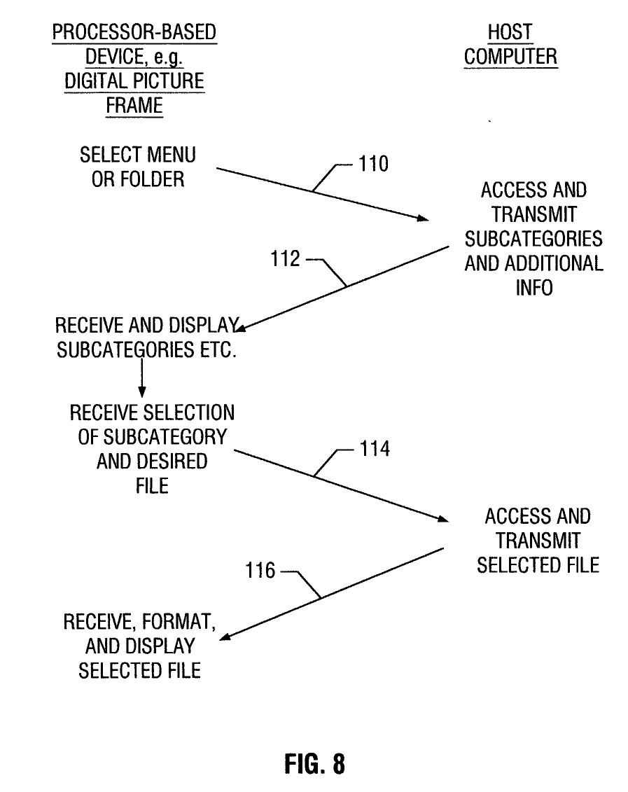

FIG. 8 is a communications diagram showing a communications sequence between a processor-based appliance and a host, in accordance with an embodiment of the present invention. The following description of FIG. 8 will also refer to processor-based appliance 10 and host 20 previously described regarding FIG. 1, as well as to the menu hierarchy described regarding FIGS. 5-7.

In a preferred embodiment, the appliance initially defaults on power-up to render its local cache of content. In the case of a digital picture frame, this includes displaying the locally stored digital images sequentially at full resolution. In the case of an e-book, the appliance could default to render the text from the most recent page viewed in the last use session. When the user desires to change the content being rendered, he or she may use the buttons or remote control to indicate his or her wish. Upon this indication, the appliance 10 may display a selection option menu. The user may proceed to select a menu or folder at any level in the file hierarchy.

As represented by arrow 110, selections are conveyed from the appliance to the host 20. The transmitted request may contain information regarding the selected menu entry and may include additional information about the items expected in return. For example, a parameter may specify which page or section of the menu information to exchange. For example, if the sub-menu selection listing were 500 items long, not only would the list take time to download, it may be unmanageable to view. The additional parameter may enable the menu to be divided into predetermined, reasonably sized pages.

The host 20 examines its file system via the pathname associated with the menu item communicated. If the menu item is a storage system folder name, the host proceeds to gather the text strings titling subcategories of information within the selected folder or menu. If the appliance registration includes pagination formatting, the host may format the sub-menu items into multiple smaller groups for transmission to the appliance. This overcomes limitations of display space at the appliance. The appliance may also have a preferred language noted in its registration information. If this is the case, menu information may be translated by the host. Once the sub-menu information is ready, the host 20 sends such information to the appliance 10, as represented by arrow 112.

Prior to the host 20 beginning the transfer of the response with requested information to the appliance 10, the host 20 may perform additional routines that format the information for the appliance's graphical user interface. This is valuable, because the resources and computing capacity of the host exceeds that of the appliance. This division of labor enables the appliance to be manufactured for lower cost.

The appliance 10 receives and displays the list of menus or sub-menus as indicated by arrow 112. The appliance 10 then awaits user selection of an appropriate item from the menu, such as a desired file.

An entry may then be transmitted to the host 20 from the appliance 10 as indicated by arrow 114. The host 20 then accesses and transmits the selected file as indicated by arrow 116. The appliance 10 then receives, formats, and displays the selected file. For expedient communication and efficiency, in one embodiment the format of the user selections to the host may comprise simple indications of which menu column and row were selected. The host may be relied upon to interpret the selection appropriately.

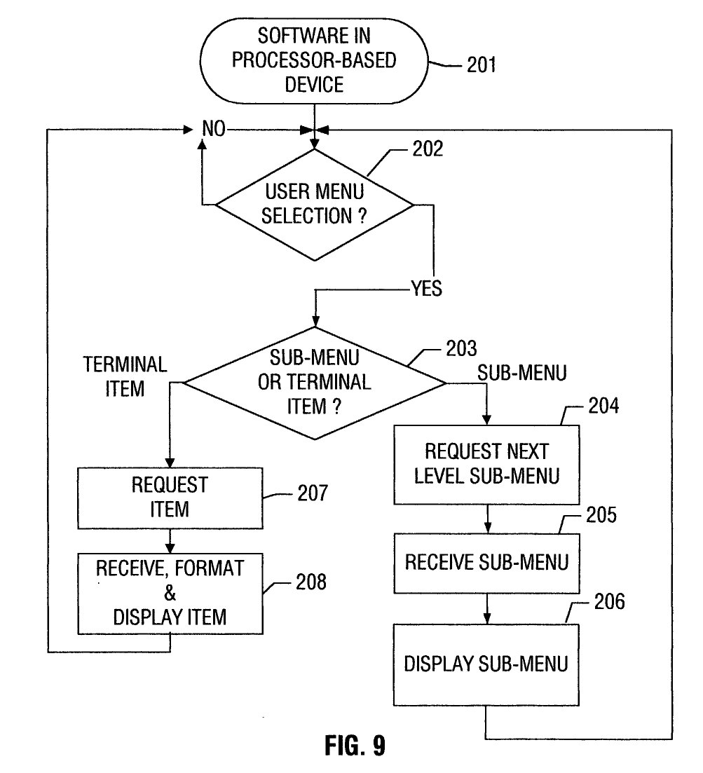

FIG. 9 is a flow diagram illustrating an exemplary method 201 to select a menu item on a processor-based appliance, in accordance with an embodiment of the present invention.

At 202, a determination is made whether the user has made a menu selection. If so, the method goes to 203; otherwise, the method loops back to the beginning of 202.

At 203, a check determines whether a sub-menu or “terminal item” was selected. A menu item is a terminal item if the hierarchy path for the next level down is the empty set. If a terminal item was selected, the method goes to 207; if a sub-menu item was selected, the method goes to 204. A terminal item, also referred to herein as a “digital media content item”, is the lowest level of the file hierarchy and usually corresponds to a digital media file such as a digital picture, video clip, music track, or literary document. For example, referring to FIG. 6, the appliance user may click on one of the individual photo thumbnails from thumbnail collections 93A or 93B to select the corresponding full-size and full-resolution digital picture.

At 204, if a sub-menu item was selected, the appliance 10 requests such sub-menu item from the host 20.

At 205, the appliance 10 receives the next level sub-menu item from the host 20.

At 206, the appliance 10 displays the sub-menu items to the user. For example, if at 204 the user had selected the “Pets” folder 84C in FIG. 5, then sub-menus in the form of thumbnail collections 93A and 93B under the headings “Fido” 91A and “Garfield” 91B, respectively, would be displayed as indicated in FIG. 6. Following 206, the method loops back to the beginning of 202 to await another user selection.

As illustrated by the examples appearing in FIGS. 5-7, both terminal items and menu items (at any level) can be represented by an abstraction on the appliance's display and/or audio renderer. The abstraction can be an icon, a photo thumbnail, a representation of a CD cover, a labeled menu box (e.g. “Neighbors” 85C, FIG. 5), a tone or melody, a spoken word or sequence of words, or the like. The abstraction is part of the GUI and enables the appliance user to see and/or hear various menu choices and to select from the choices. The abstraction is rendered into a human-perceivable form by the appliance's visual display renderer (17, FIG. 2) and/or audio renderer (18, FIG. 2).

At 207, the selected terminal item is requested from host 20. Each terminal item, such as a digital picture, is uniquely associated with a suitable digital media file by means of a host pathname identifier, which can be a unique file name and which may also comprise a date and time stamp, as well as any other appropriate information.

At 208, the terminal item is received from host 20, and it may be optionally decompressed if necessary. It is then rendered on the appliance 10.

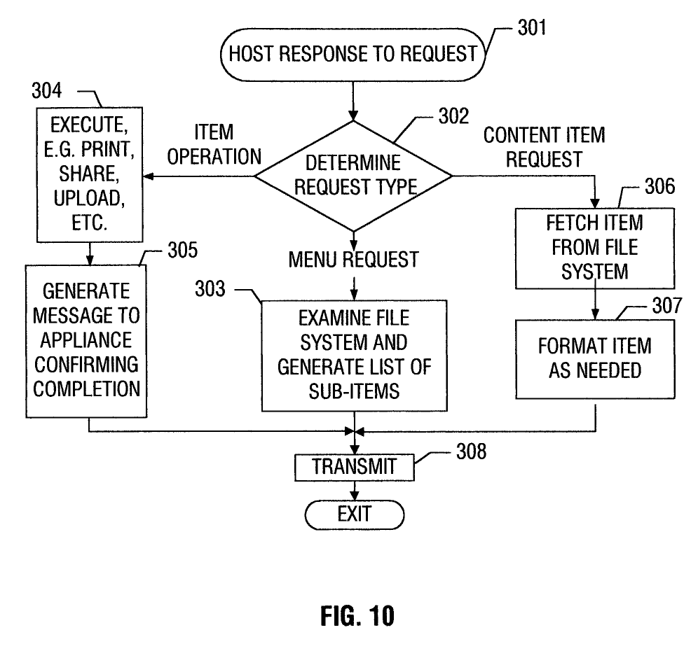

FIG. 10 is a flow diagram illustrating an exemplary method 301 for a host to respond to a request from a processor-based appliance, in accordance with an embodiment of the present invention. Through this method, an appliance user can conveniently perform many types of file operations. As merely one example, the appliance user can request that the host queue a specific photo file to a printer, waiting until the user loads photo paper into the printer. The appliance user can also send photos to a buddy for sharing. The appliance user can also request that the host send a menu of stored media files to the processor-based appliance, from which the appliance user can select one or more files for any desired purpose, such as a file to be rendered on the processor-based appliance.

At 302, a determination is made as to whether the request from the appliance is for an item operation, a menu request, or for a content item. For efficiency, each of these operations has an established command code. The command codes for these various operations can be an established part of the host-appliance communication protocol.

If the appliance request is for an item operation, the method goes to 304; if it's for a menu request, the method goes to 303; if it's for a content item request, it goes to 306.

An “item operation” is an operation that the host performs at the request of the appliance. Generally, an item operation is a unique operation that the host can perform, and that the appliance may not be able to perform. Examples include printing a file, transmitting a file to a buddy, uploading a file to the host for archival storage, and so forth.

At 304, the host performs the requested item operation(s).

At 305, the host generates a message to the appliance confirming completion of the requested item operation(s), and the message is subsequently transmitted to the appliance at 308. The appliance may give the user a confirmation indication.

At 303, the host examines its file system and generates a list of information items that will be used to populate the sub-menu, depending upon the selection made at the processor-based appliance. The sub-items, which may comprise text strings describing storage hierarchy levels, photo thumbnails of digital media within a level, and so forth, are transmitted to the appliance at 308. The appliance prepares the next user selection display by populating the menu structure with the newly received sub-menu items.

At 306, the host fetches the requested content item from its file system.

At 307, the host optionally formats the requested content item if necessary to render properly, given the registered characteristics of the appliance. For example, a multi-megapixel digital image may be down-sampled to match the appliance's display resolution and color-corrected to fit the appliance's color gamut. The requested content item is then transmitted to the appliance at 308.

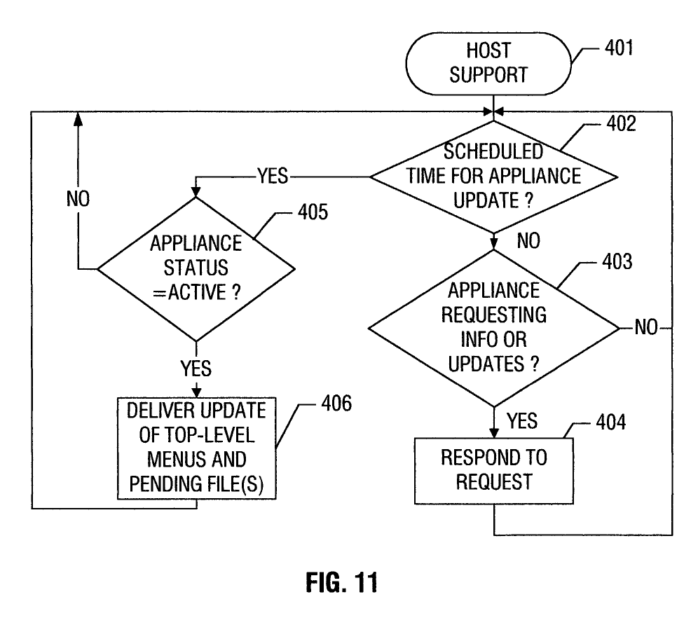

FIG. 11 is a flow diagram illustrating an exemplary method 401 for a host to provide support to and/or to update a processor-based appliance, in accordance with an embodiment of the present invention.

In 402, a determination is made whether it is a scheduled time to update the content and menus for an appliance. If so, the method goes to 405; otherwise, it goes to 403. The user can schedule the host to update the appliance at any desired periodic interval, at specified clock times, or according to any other type of time schedule. The host application supporting the appliance uses host system resources to maintain a registration data record for each registered appliance, including preferred update schedule information. The registration process is described more fully in a forthcoming section of the written description.

At 403, a determination is made whether the appliance is requesting information or updates. If so, the method goes to 404; otherwise, it loops back to the beginning of 402.

At 404, the host responds to the appliance's request for information or an update. Such information can be of any type, such as the current date, time of day, a host locale identifier that identifies its physical location (e.g. city), accessible image galleries, picture-sharing buddy lists, a software update, and the like.

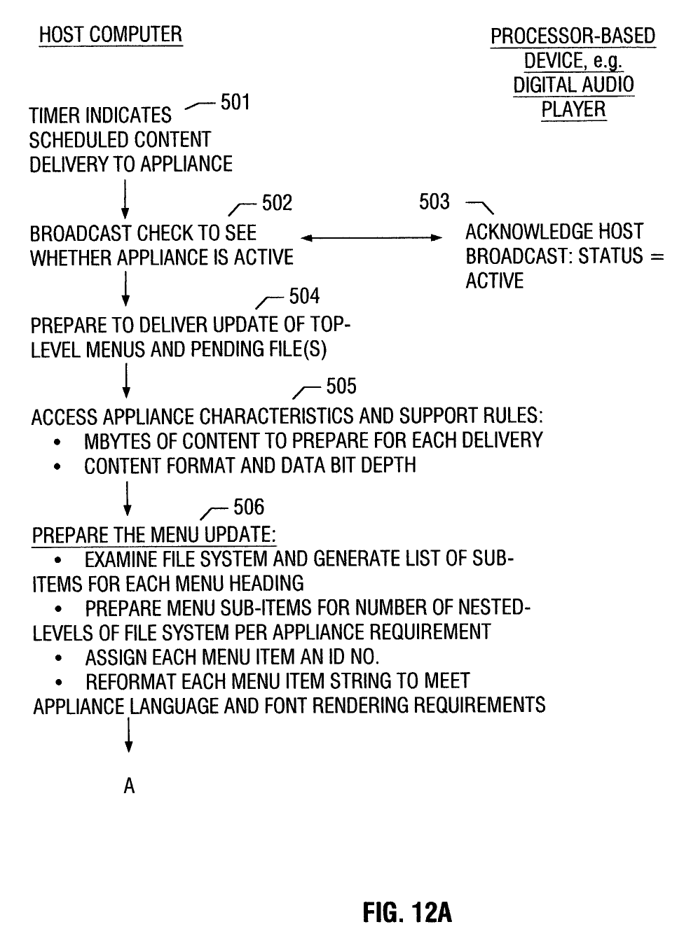

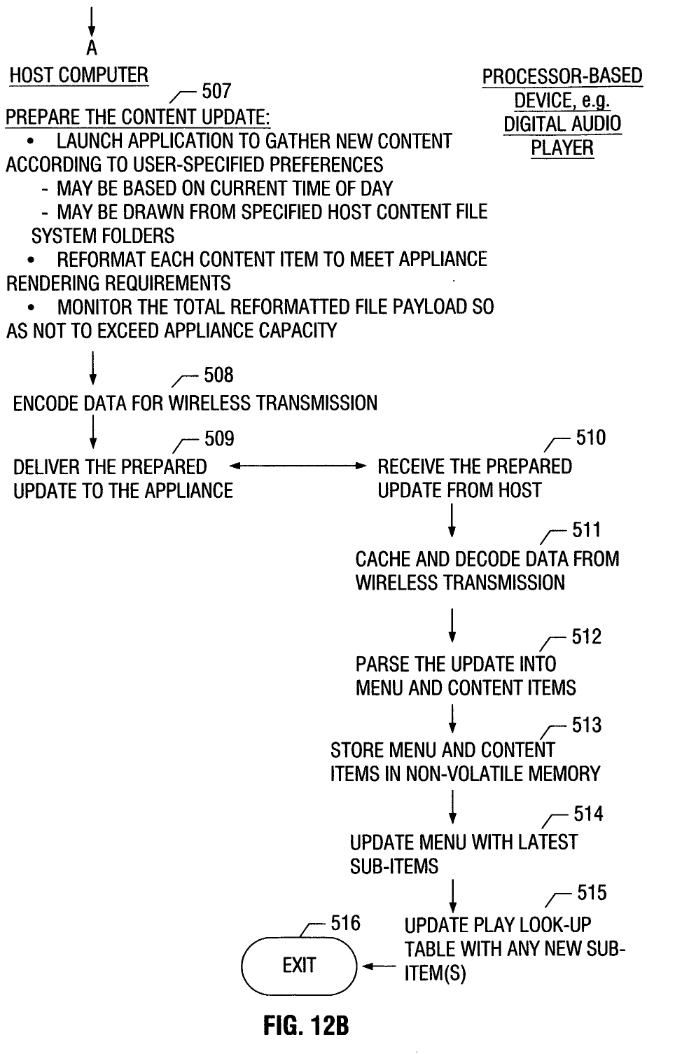

At 405, when it is time to deliver a scheduled update of content and menu items to an appliance, a determination is made whether the appliance's status is “Active”. (The method for determining the appliance's state is described in detail in the forthcoming description of FIG. 12.) If so, the method proceeds to 406; otherwise, it loops back to the beginning of 402.

At 406, the host delivers an update of top-level menu, e.g. menu categories such as 82A-82C in FIG. 5, if there has been any change in such top-level menu since the previous update. Such change could result, for example, if the user has recently added or deleted a category from his or her digital media archive file hierarchy on the host. Also at 406, the host can deliver new digital media files to the appliance.

FIGS. 12A and 12B together constitute a combined flow diagram and communications diagram illustrating an exemplary method for a host to update a processor-based appliance, such as a digital audio player, in accordance with an embodiment of the present invention. This update sequence expands slightly upon that shown in FIG. 11.

At 501, a host system resource such as a timer indicates that it is time for the host to deliver menu items or content items to an appliance, such as a digital audio player, a digital picture frame, or any other processor-based device.

At 502, the host broadcasts a check to see whether this appliance is active. This is commonly done in the art by means of the host periodically broadcasting a request for response. Each appliance is polled to check whether it is still able to participate fully. If so, at 503 the appliance acknowledges the host broadcast by responding to the host that it is active.

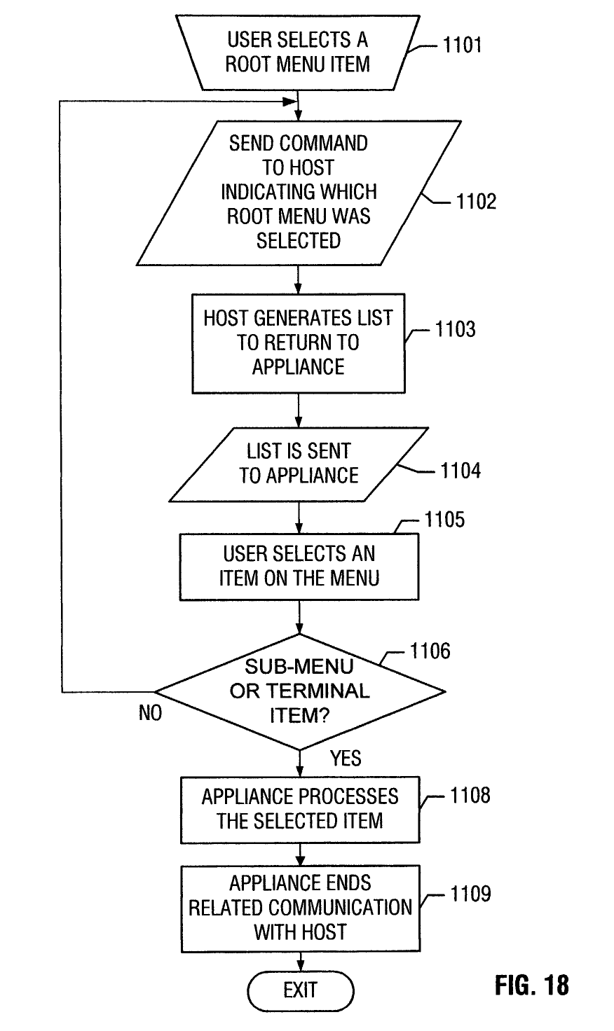

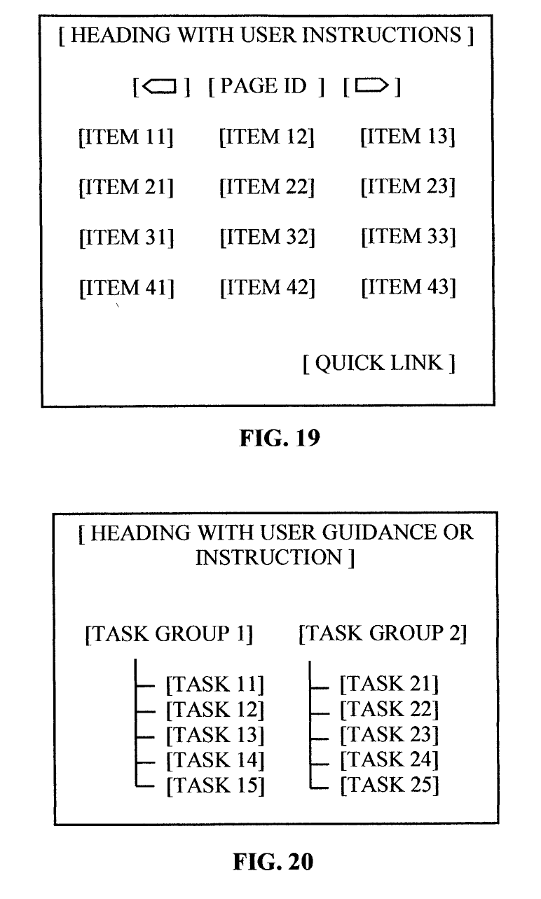

At 504, the host begins to prepare an update of any changes to the top-level menus, any pending files that have been received for but that have not yet been delivered to the appliance, and optionally, automatically selects a new collection of digital media for the appliance. The latter capability is described further in FIGS. 18 and 19.

At 505, the host accesses information from within its local memory regarding particular characteristics and support rules of the appliance. These can include, for example, the maximum storage and formatting requirements of the appliance. The host can thus calculate the maximum size, content format, data bit depth, and other characteristics of each delivery to the appliance.

At 506, in a preferred embodiment, the host prepares a top-level menu update. This can involve a variety of operations. For example, the host can examine its file system and generate a list of sub-items for each menu heading or category heading. The host can prepare menu sub-items for a number of nested levels of the file system, conforming to the stored registration parameters defining the capabilities and configuration of the appliance. The host can assign each menu item an identifier number. The host may reformat each menu item string or group to meet language and font-rendering requirements of the appliance. The host may also reformat each visible and audible menu item to conform to the appliance's rendering capabilities. For example, album cover thumbnails may be converted to JPEG (Joint Photographic Experts Group) format and music tracks to MP3 (Moving Picture Experts Group, audio layer 3) format.

At 507, the host may determine the byte payload size of digital media content waiting to be delivered to the appliance. The waiting content may be user-selected at the host, received from another user's computing device, or gathered from the archive on behalf of the appliance. The host can launch an application to gather new content items according to user-specified preferences that are stored within the host. The content selections update can depend upon the current time of day; for example, quieter songs can be selected for the user in the morning and more energetic songs can be selected for an update later in the day.

The content item(s) can be retrieved from specified content file system folders on the host. The host, if necessary, can reformat each content item to meet the rendering requirements of the requesting appliance. For example, an MP3 player may require that all 16-bit songs be converted to 12-bits and to MP3 format prior to transmission. For example, a bitmap file may be converted to a JPEG format prior to transmission. As another example, large image files, such as video files, can be divided into more readily transmissible portions. The host can monitor the total size of the reformatted content payload so that it doesn't exceed the storage capacity of the appliance and is transmitted at a rate not to exceed the transmission bandwidth. In another embodiment, reformatting could be performed by the appliance. However, it is preferred to divide the workload so that the appliance is required to do only minimal content processing, such as decompressing transmissions. This gives the benefits of faster responses to user requests and minimizes appliance cost.

In some embodiments, the host has greater storage and processing resources than an associated appliance, so the host can take on such tasks as storing large quantities of media files and properly formatting such media files and menu information for display on the appliance. This division of workload or responsibility enables the appliance to contain fewer storage, processing, and possibly other resources, so that it can be manufactured at a substantially lower cost than the host.

At 508, the host encodes the information to be wirelessly transmitted.

At 509, the host transmits the prepared update to the appliance.

At 510, the appliance, e.g. a digital audio player or other processor-based device, receives the prepared update from the host.

At 511, the appliance stores and decodes the update data that has been transmitted, e.g. wirelessly, from the host.

At 512, the appliance parses the update into menu items and content items.

At 513, the appliance stores the menu items and content items in non-volatile memory.

At 514, the appliance updates its menu with the latest menu items, such as text strings conveying names of archive categories, thumbnail images representing digital content items, or other representations, such as icons, of digital content menu items, and sub-menu items.

At 515, the appliance updates its play look-up table with any new sub-item(s) received from the host. The play look-up table is a play list or sequence of digital media files in a play order. For example, if the appliance is a digital audio player, the play list comprises audio files; if the appliance is a DPF, the play list comprises digital photos. The play list defines the order in which digital media files are to be rendered on an appliance. The play list can optionally include transition effects, as well as visual and/or audio captions to identify files as they are rendered. The play list also includes the appliance's local memory address where each digital content item has been stored.

As just one example, the method shown in FIGS. 12A-12B could be used by an electronic music player in an automobile that communicates with a host entertainment system within the automobile, or with an external wireless host, in order to obtain a new download of music files.

The method finishes at 516.

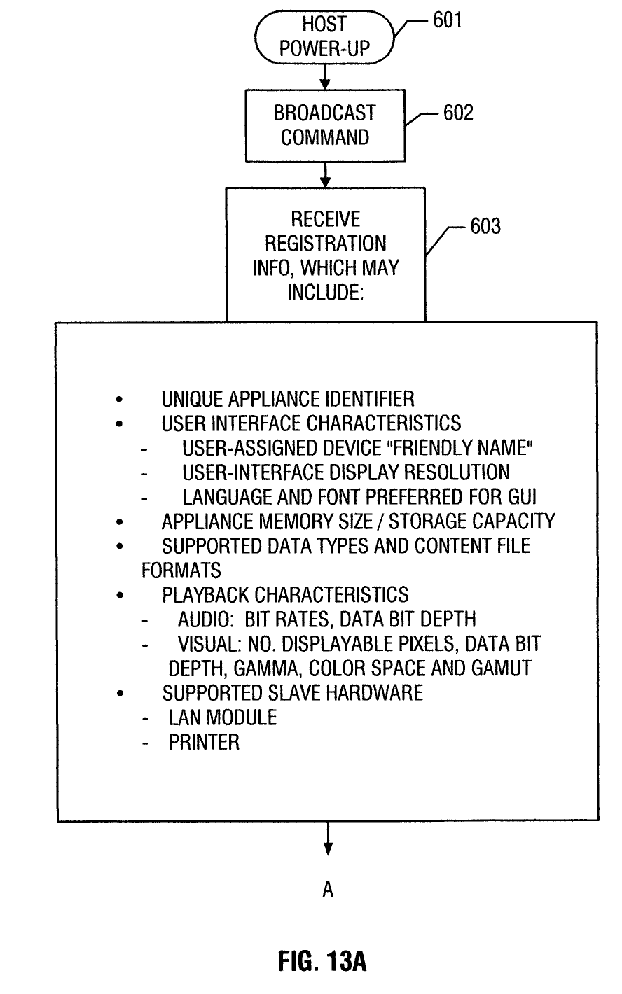

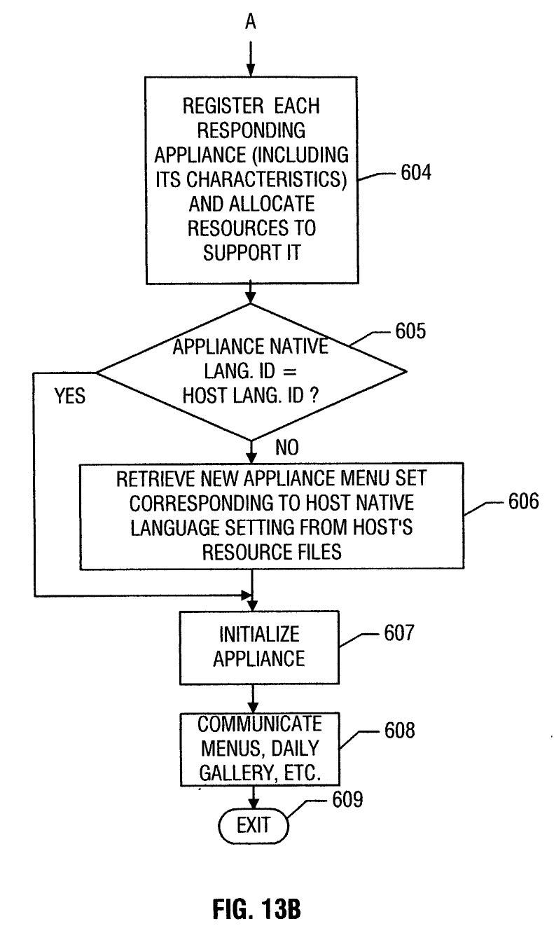

FIGS. 13A and 13B together constitute a combined flow diagram illustrating an exemplary method 601 for a host to power up, in accordance with an embodiment of the present invention.

At 602, when the host is turned on, it broadcasts a polling inquiry or command for any appliances in its vicinity to respond and to register with it.

At 603, the host receives back from each appliance various registration information, which can include a wide variety of information. Such information can include a unique appliance identifier (ID) for each appliance that responds. The information can include user interface characteristics, such as a user-assigned “friendly name” for the user's appliance, the display resolution of the appliance, a preferred language and font for the appliance's general user interface (GUI).

The information can also include the memory size or other indication of storage capacity of the appliance. The information can include a list of the data types and content file formats that the appliance supports.

The information can further include playback characteristics. For audio files, this can include the bit rates and data bit depth. For visual files, this can include the number of displayable pixels, data bit depth, gamma, color space and gamut.

The information can also include one or more hardware support descriptors comprising information about any supported slave hardware, such as a local area network (LAN) module, a printer, and the like.

The appliance characteristics are used by the host in tailoring updates to the appliance. For example, when digital pictures are received by the host in an e-mail, and they are in a specific format, such as the JPEG file extension, they may be automatically distributed to the appliance. Similarly, when downloaded software is received by the host, such as video-on-demand software that is specially adapted for the appliance, such software may be automatically forwarded to the appliance. As another example, downloaded software may be specifically adapted for a specific processor, and that may also be indicated with the download. Because the host knows the processor of the appliance, the host may automatically forward the software to the appliance.

As yet another example, one of the appliance characteristics stored by the host can be a preferred language identifier that indicates in what natural language (e.g. English, French, etc.) the appliance user prefers to read text items, such as menu information. When the host updates the appliance, the host can retrieve and provide text information, such as a menu set, in the preferred language of each appliance with which it is communicating.

In some embodiments, the appliance automatically adopts the pre-selected hierarchy in organization of menus and files that exist on the host. This avoids the necessity to re-specify the hierarchy, menu structure, and the like, from the appliance. Thus, generally, the appliance will use the same number of hierarchical levels, the same hierarchical descriptors and titles, and the like, as the host.

At 604, the host registers each responding appliance, including its unique ID number and its particular characteristics, and the host allocates resources to support each responding appliance. If the responding appliance has previously been registered by the host, the host records that such appliance is currently active.

At 605, a determination is made whether a native language identifier for the appliance is the same as the language identifier for the host. If so, the method goes to 607; if not, it goes to 606.

At 606, the host retrieves a new appliance menu set corresponding to the host's native language setting from the host's resource files.

At 607, the host initializes the appliance.

At 608, the host communicates menus, a daily gallery or play list, and any other like information to the newly registering appliance. Such information can include time of day, current date, locale identifier or physical location of the host (e.g. city), and the like.

In one embodiment, new multi-megapixel resolution digital pictures are not necessarily transmitted to the appliance during updates, because it is a more efficient use of transmission bandwidth to send only the highest resolution the appliance can utilize. It is preferable to down-sample higher resolution images. Also, oversize image data unnecessarily consumes the local storage resources of the appliance.

Update information can be communicated both upon request of the appliance and at periodic intervals, e.g. hourly or daily. The gallery or play list can be rendered on the appliance, including at times when the host may be powered off or out of range. The method ends at 609.

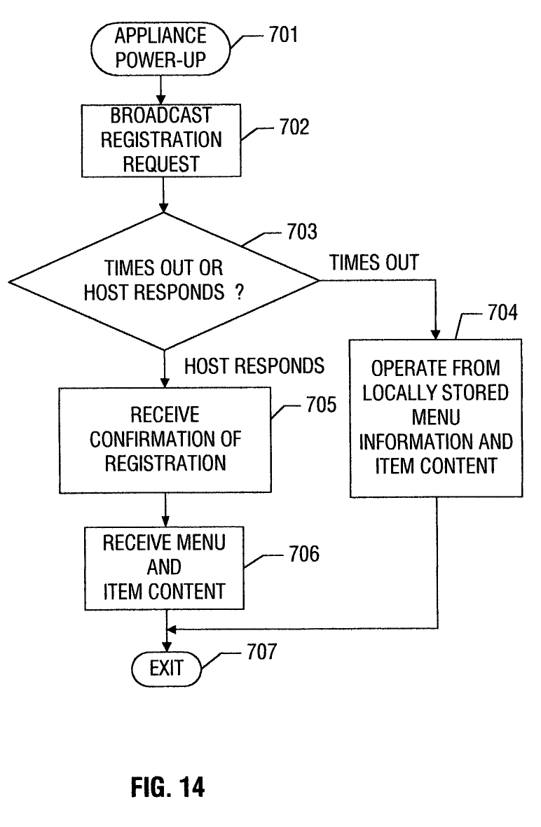

FIG. 14 is a flow diagram illustrating an exemplary method 701 for an appliance to power up, in accordance with an embodiment of the present invention.

At 702, the appliance broadcasts a registration request to see whether a host is within range and is powered on.

At 703, a determination is made whether the host has responded within a specified time. If so, the method goes to 705; if not, it goes to 704.

At 705, the appliance receives confirmation of registration from the host. If the particular appliance has not previously registered with this host, then it can register with the host in a manner similar to that described above regarding FIGS. 13A-13B.

At 706, the appliance receives one or more menu items and/or one or more content items.

At 704, the appliance operates from its local store of menu information and content items. The method ends at 707.

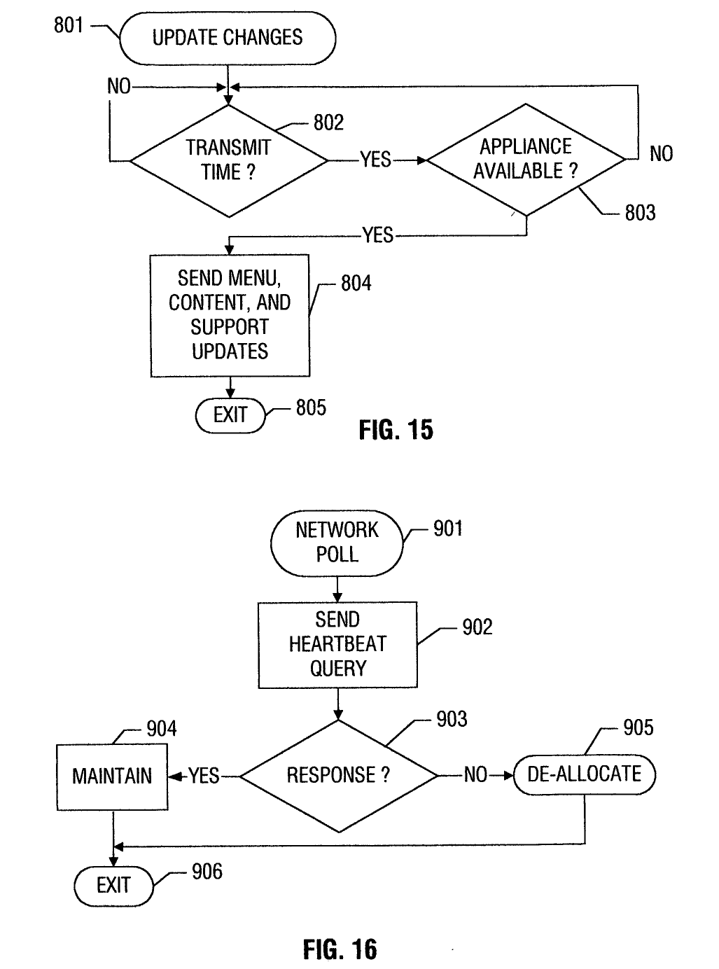

FIG. 15 is a flow diagram illustrating an exemplary method 801 for a host to synchronize with a processor-based appliance, in accordance with an embodiment of the present invention. As a result of synchronization, the host updates the appliance with any menu or content item changes residing on the host. Such updates can occur automatically or upon command from the host or appliance.

At 802, a determination is made whether a scheduled transmit time has occurred. If so, the method goes to 803; otherwise, it loops back to the beginning of 802.

At 803, a determination is made whether the appliance is turned on and within range. If so, the method goes to 804; otherwise, it loops back to the start of 802.

At 804, the host sends any updates to menu items, content items, or support items. Support items can include a new software or driver release to provide one or more functions or characteristics that the appliance did not previously have, or an updated version thereof.

A new function could be accompanied by a new menu item for display on the appliance, e.g. a printing icon denoting a printing action that the user can command to occur on a selected file at the host. The host can deliver a new menu template to support a new function or capability, thereby altering or expanding the feature set for the user automatically. This capability overcomes many of the existing limitations of product shipping readiness and competitiveness for manufacturers. The method exits at 805.

FIG. 16 is a flow diagram illustrating an exemplary method 901 for a host to poll one or more processor-based appliances, in accordance with an embodiment of the present invention. A purpose of such polling is to determine whether an appliance is powered on and within range. When an appliance is powered down, it can send an appropriate signal to its host. However, the appliance user could possibly carry an appliance out of range of its host, so a mechanism is provided for the host to poll the status of any nearby appliance(s). In one embodiment, such polling is performed at periodic intervals by the host to determine which appliances are active in a network.

At 902, the host may automatically send a “heartbeat” query, such as a null packet, to a selected appliance, or it could broadcast such a query to any and all listening appliances, and then wait for the appliances to respond within a predetermined interval.

At 903, a determination is made whether a specific appliance has responded to the heartbeat query. If so, the method goes to 904, where the appliance is maintained as “active” on the host's registry of active appliances. This allows the responding appliance to receive periodic updates from the host.

If the appliance failed to respond, the method goes to 905, where the host de-allocates the appliance from its registry of active appliances and does not process any transmissions to such appliance until it is re-registered.

When an inactive appliance comes back on line or is within sufficient proximity to receive signals from the host, the appliance may be automatically updated the next time that the host sends out an appropriate heartbeat signal, such as in 902. Alternatively, whenever the appliance is turned on, it may broadcast a signal to the host indicating that the host should allocate resources to the processor-based appliance.

FIG. 17 is a block diagram of a network comprising a host 1002 and one or more processor-based devices or appliances 1010, 1012, and 1014, in accordance with one embodiment of the present invention. As illustrated in FIG. 17, a host 1002 can communicate menu items and content items with one or more processor-based devices, such as appliances 1010, 1012, and 1014. Host 1002 generally comprises greater resources, and/or larger and more full-featured resources, than an individual processor-based appliance 1010, 1012, or 1014. For example, host 1002 can include storage for a large-content file repository that contains many digital media files of any type. Host 1002 can also include a file structure or system that is organized by a host user. As one example, many personal computer users use the large storage capacity of their personal computers to store digital media files, after downloading such files from the Internet, from digital cameras, or from other media players, or after receiving them via email. Computer users typically establish a preferred, customized file hierarchy on their personal computers. Embodiments of the present invention offer significant flexibility in accommodating computer users' pre-existing file hierarchies, thus providing an advantage over other products that are incapable of doing so.

Host 1002 can further comprise a large cache memory. Host 1002 can also include fairly significant processing power to search for and reformat digital content items, whether in its local memory or on a network such as the Internet. Host 1002 can also include a full-featured general user interface (GUI), as well as a number of timers, schedulers, and other application resources. Host 1002 may also include a wireless communications module, including for example a radio-frequency (RF) or infra-red (IR) transceiver.

In the example shown in FIG. 17, host 1002 can communicate wirelessly with appliance 1010 and appliance 1014 via wireless links 1004 and 1006, respectively. Host 1002 can communicate via a cable or wire 1008 with appliance 1012.

An appliance generally comprises fewer resources, and/or smaller and less full-featured resources, than a host. For example, appliance 1014 can include storage for a small-content file repository that may contain a limited number of digital media files. The file system organization of appliance 1014 can adapt to that of the host, including the file names or labels of the host. Appliance 1014 could have a small cache memory and only sufficient processing power to render specific content types. For example, a DPF could have a processor that renders only digital photo files. Appliance 1014 could have a limited-feature GUI, and other rather limited application resources. Appliance 1014 may also include wireless or wireline communications modules, including for example a radio-frequency (RF) and infrared (IR) transceivers as described previously in FIGS. 1-3.

In a network or system comprising a host computer and at least one processor-based appliance, resources can be divided in a suitable division of labor and/or partitioning of responsibility. For example, in an embodiment where the host serves as a repository for a large number of digital media files, the storage capacity of the processor-based appliances can be reduced to a reasonable capacity that can store a reasonable number of files, thus minimizing the cost and complexity of the processor-based appliances.

### Updating of Menu Information from a Host to an Appliance

The following description relates to additional features that enable a processor-based device, such as an appliance, to easily retrieve and utilize menu information from a host computer archiving a plurality of digital media files of any type arranged in a file structure, also of any type. The appliance user can receive menu information from the host to facilitate the retrieval of desired media files from the host and from the appliance.

FIG. 18 is a flow diagram illustrating an exemplary method 1101 for an appliance to obtain menu information from a host, in accordance with an embodiment of the present invention. The method may be initiated, for example, by the host on a regular schedule as well as by the user requesting new content for the appliance. The user request is indicated by the user's selecting a menu item offering this option.

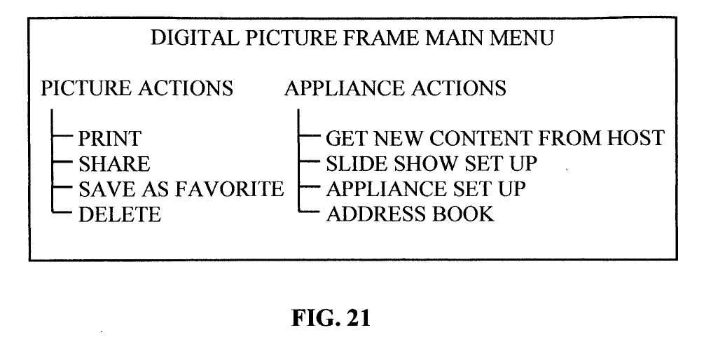

“Root menu items” are high-level menu items. Examples of root menu items are the categories “Picture Actions” and “Appliance Actions” in the graphical user interface (GUI) depicted in FIG. 21. To request new digital media content for the appliance, the user may select “Appliance Actions”, and then select “Get new content from host” from a subsequent sub-menu.

Referring again to FIG. 18, in 1102, when a host-supported task is selected, a command is sent to the host. For this task, the appliance request to the host indicates that new content is desired. Depending on the capability of the appliance, the request may simply be a command with positional parameters indicating which menu item was selected by the user, or it may be a request with more prior interpretation, so that the nature of the request is indicated. Also, contextual information, e.g. a menu ID or menu component ID (e.g. a page ID), may be sent to help in retrieving the proper menu information to be sent to the appliance for display.

In 1103, the host determines what the request is and, following the previous example in which new content was requested, the host generates a list comprising text strings, icons, or other suitable menu information to convey the choices of relevant digital media file content available. The registration information for the appliance guides the type and style of menu information to be sent to the appliance. The menu information can be a portion (up to 100%) of the host's file structure. This menu information typically represents menu information in the next level down in the menu hierarchy or file structure. For example, if the user made a selection of a particular folder in 1102, then in 1103 a list of the available media content subfolder names or actual media items in that folder would be generated. The list of items are subsequently used for populating the appropriate menu template at the appliance It will be understood that the terminology and organization of the menu hierarchy or file structure can be varied in any desired manner, and that the particular implementations given herein are merely examples.

In 1104, the list of menu items is sent to the appliance and populates the template for display.

Before continuing with a discussion of 1105 of FIG. 18, first FIGS. 19, 20, and 21, which illustrate examples of menu templates, will be discussed.

FIG. 19 shows an example of a template for a menu that provides selections for digital media content. The field for “Heading with User Instructions” can be populated with text strings in a preferred language, font, and resolution. An example of the type of information that could populate this field is “Select a photo from Pets” when the user has browsed through the content hierarchy to his “Pets” folder. The second row of three fields in this sample template enables the display of forward and backward scrolling through the menu pages for “Pets”. The “Page ID” and need for pagination have been described already. These assist in displaying a comfortable, viewable set of images per display page, and yet they provide access to all digital media content items or sub-folders. The host breaks the menu items into pages based on the registration requirements for a particular appliance.

The next four lines of fields are item locations. These may be populated with the icons, text strings, photo thumbnails, or other representations of selectable items. The “Quick Link” field at the bottom of this template enables the display of a quick link. The “Quick Link” field may be desirable to help the user quickly return to a higher level in the hierarchy or to the main menu. The “Quick Link” field enables these options.

FIG. 20 depicts an example of a root menu template. This template also starts with a field (e.g. “Heading with User Guidance or Instruction”) for placement of instructional information or titling. The next two fields in the following row provide titles for the task groups available from the root menu. They are not selectable fields, merely titling fields, in this example template. Under each task group heading are the fields for tasks with a common scope.

FIG. 21 depicts an example of a root menu populated with menu items. In this example, the root menu is assumed to be used within a digital picture frame appliance. The heading field has been populated with a text string reading “Digital Picture Frame Main Menu”. In this embodiment, the two task categories depicted are “Picture Actions” and “Appliance Actions”.

Under “Picture Actions” are fields populated with commonly-desired actions to be performed on a particular image. Examples shown include “Print”, Share”, “Save as Favorite”, and “Delete”. These are selectable fields.

Under “Appliance Actions” are fields populated with common appliance tasks, including “Get New Content From Host”, which initiates retrieval of new content from the host. Next is “Slide Show Setup”, which causes the display of a menu for displaying pictures in a slideshow including, for example, inter-picture delays, transition effects, audio accompaniment, etc.

Next is “Appliance Setup”, which causes the display of a menu to allow the user to view and alter aspects related to the appliance behavior, such as the times of day when the appliance turns its display on and off, and its “friendly name” that is used also by the host to distinguish this appliance from others like it. The last appliance task illustrated is “Address Book” which causes the appliance to display a menu that controls the locally-stored Internet addresses of buddies. This menu gives the user a way to review a list of friends and family who are to be included for easy image sharing. In other embodiments, templates of many types can be used to support appliances of many varieties.

As the host prepares a list of items for display, it can include a parameter that indicates to the appliance which template is best suited for the information being transmitted. Relatively more capable appliances can similarly request new items to populate a specific menu template. This method enables the host to support a range of appliance capabilities. Relatively less capable appliances may rely on the host entirely for interpretation and menu preparation. Relatively more capable appliances can operate somewhat more independently, particularly when the host is not available.

Now referring back to FIG. 18, in 1105, the appliance user selects an item on the menu.

In 1106, a determination is made whether the selected item is a sub-menu or terminal item. If so, the method goes to 1108; otherwise, it goes back to 1103. Again, in different embodiments different menu nomenclature and different menu hierarchies could be used. For example, in another embodiment, the alternatives in 1106 could be different. The user may make interface selections to selectively move to lower levels in the file hierarchy. Also, the user may go up one or more levels in the file hierarchy, if desired, through the use of a suitable file navigation icon, such as an “up” arrow.

In 1108, the appliance processes the selected item. This may include decompressing and putting items into local storage.

In 1109, the appliance determines what it needs to do with the selected item and ends related communication with the host.

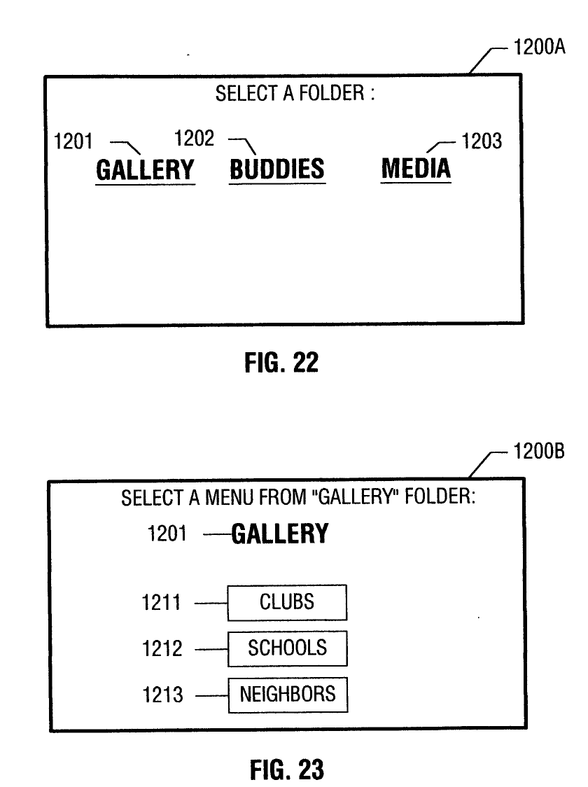

FIG. 22 illustrates a depiction of a plurality of folders 1201-1203 of a graphical user interface (GUI) 1200A displayed on a display of a processor-based appliance, in accordance with an embodiment of the present invention.

The menu structure of GUI examples 1200A-1200D illustrated in FIGS. 22-25, respectively, differs from the menu structure of the GUI examples 80A-80C depicted in FIGS. 5-7, respectively, merely to illustrate that embodiments of the present invention can accommodate many different implementations.

Still referring to FIG. 22, in GUI 1200A, three folder choices in the form of “Gallery” 1201, “Buddies” 1202, and “Media” 1203 are presented. The appliance user makes a choice by selecting the desired folder, e.g. “Gallery” 1201, causing the screen to display GUI 1200B shown in FIG. 23.

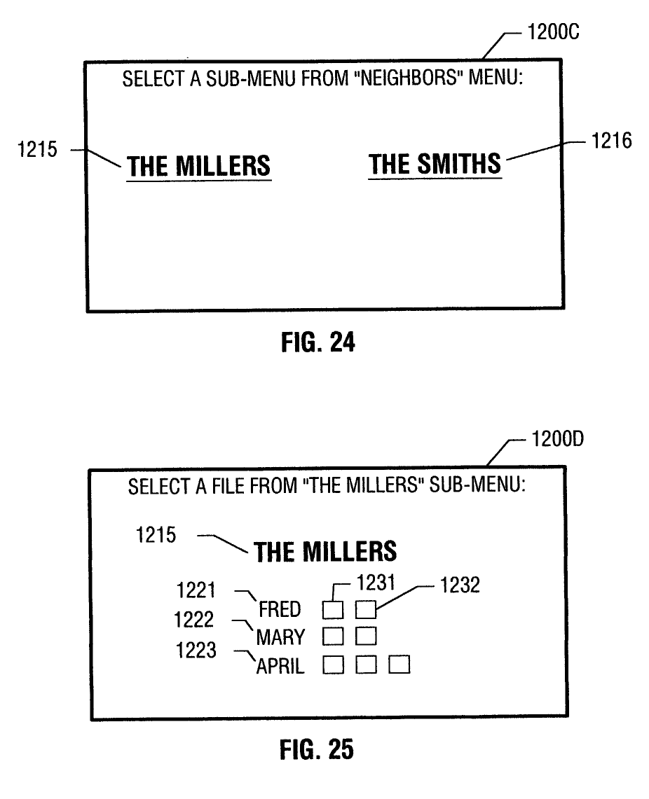

FIG. 23 illustrates a depiction of a plurality of menus 1211-1213 within the “Gallery” folder 1201 of graphical user interface 1200B. In GUI 1200B, three menu choices in the “Gallery” 1201 folder are illustrated. These three choices are the “Clubs” 1211, “Schools” 1212, and “Neighbors” 1213 menus. The appliance user makes a choice by selecting the desired menu, e.g. “Neighbors” 1213, causing the screen to display GUI 1200C shown in FIG. 24.

FIG. 24 illustrates a depiction of a plurality of sub-folders 1215-1216 of graphical user interface 1200C. In GUI 1200C, two sub-folder choices in the “Neighbors” folder are illustrated. These two choices are “The Millers” 1215 and “The Smiths” 1216 sub-folders. The appliance user makes a choice by selecting the desired sub-folder, e.g. “The Millers” 1215, causing the screen to display GUI 1200D shown in FIG. 25.

FIG. 25 illustrates a depiction of a plurality of media file thumbnails 1231-1232 within “The Millers” sub-folder 1215 of graphical user interface 1200D. In GUI 1200D, a number of media file thumbnails, including thumbnails 1231-1232, are illustrated. The appliance user makes a choice by selecting the desired thumbnail, causing the screen to display the selected file. In addition to, or instead of, displaying the selected file, the selected file could be used for any other purpose on the appliance, depending upon the features and capabilities of the particular appliance.

Alternatively, in GUI 1200D, the headings “Fred” 1221, “Mary” 1222, and “April” 1223 could be presented as a hierarchical level, e.g. as sub-sub-folder items, and in response to selecting one of them, yet another level of screen could be displayed to the appliance user showing a plurality of media files thumbnails corresponding to the selected person, e.g. “Fred” 1221.

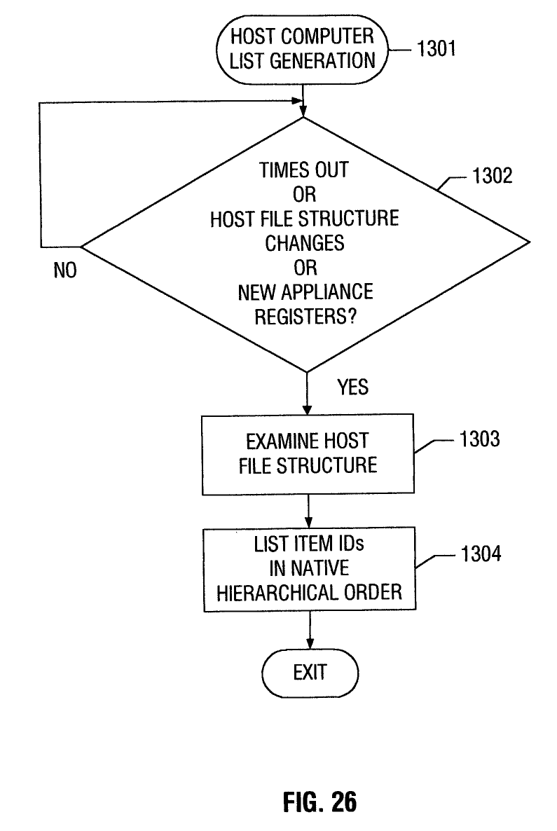

FIG. 26 is a flow diagram illustrating an exemplary method 1301 for a host computer to generate menu information, in accordance with an embodiment of the present invention.

In 1302, a determination is made whether any of several conditions has occurred. If so, the method goes to 1303; otherwise, it returns to the beginning of 1302. In this example, the conditions include (1) an expiration of a time period (e.g., a time-out by an interval timer), (2) a change in the host file structure, and (3) the registration of a new appliance. Regarding (2), such a change can include an addition to the file structure, a deletion from the file structure, a regrouping in the file structure, and a renaming in the file structure.

In 1303, the host software examines its digital media content file archive structure. During this operation, the host software can establish item names, host file path identifiers and item menu template position identifiers (IDs) for each item in the file hierarchy, for example. The host may keep a record of the folder above and below each item in the hierarchy.

In 1304, the items and associated information are listed in their native hierarchical order. The resulting hierarchical list of file information is then ready to transmit to an appliance, which can occur, for example, at the next scheduled update, or upon request of the appliance user, etc.

The operations described above with respect to the methods illustrated in the figures can be performed in a different order from those described herein. Also, it will be understood that while an “exit” block is shown in some figures, these methods can be performed continuously.

Several other embodiments and examples of how embodiments of the present invention may be used to enable an appliance user to easily access and retrieve desired media files on a host will now be discussed.

Let us assume that an appliance, such as a DPF, has its root menu organized into three folders, as shown in the example of FIG. 22. Assume that the appliance's menu is going to be updated with current file information residing on a host. The file information exchange may be initiated either by the host or by the appliance. For the purposes of this example, consider a wireless DPF initiating the request.

Consider a request to update the DPF's “Gallery” folder. The DPF sends a command (CMD_GET_MENU) to the host software with a parameter specifying which system folder (MNU_GALLERY_LIST) this request pertains to. It also can send context information, such as the ID of the gallery to retrieve.

Upon receipt of the command, the host gathers the current file hierarchy information, formats it into the preferred language specified by the particular requesting DPF, and transmits the result to the DPF. The exchanged list contains the items to populate the menu (MENUTXT), and it may include additional information about each item (e.g., ID, ITEMTYPE).

An additional parameter may be added to specify which page or section of a menu's data to transmit. For instance, if a list were 500 items long, not only might it take considerable time to download, it might be quite unmanageable from the viewpoint of the DPF's user. However, with the additional parameter, the host can prepare the menu information divided into a plurality of reasonable page sizes.

After the appliance completes the download of the list of menu information, it performs the routines required to abstract it to its GUI, and to populate the menu items into the correct template fields.

When an item from the menu is selected, the appliance considers what it needs to do with the selection based on the actions requested by the user (e.g. which task category is being executed). If the user selects the appliance task to get new content and then the “Gallery” folder, the appliance would issue a command (CMD_GET_GALLERY) to retrieve the contents of the “Gallery” folder, and the appliance would process the download request with the host.

Similarly, in an example of a “Buddy” list retrieval, the appliance would initiate the command CMD_GET_MENU with the parameter MNU_BUDDY_LIST with the contextual information specifying the ID of the “Buddy” list menu. Again, each menu item can be enumerated, and the displayable content (e.g. in ASCII or in pre-fonted bitmaps) can be tagged with additional properties. After the appliance receives an initial list of “Buddy” menu entries, the process may be nested to retrieve a list of buddies within a selected group. In the event the appliance user selects an item pertaining to a sub-group, the appliance would then issue the CMD_GET_MENU command, with the selected sub-group's ID given as context information rather than the root.

The MNU_BUDDY_LIST parameter would be again passed and this would cause the data exchange process to repeat with the new selections. If the appliance user selected a particular buddy (assuming this was to initiate sending a picture to a buddy), the appliance would then issue a command (CMD_SHARE_FILE, for instance) to the host software, along with the ID of the buddy (given by the selected menu item) and the ID of the file to be shared.

It is possible that some appliances will incorporate enough memory to hold menu items in local storage. In such a system, menu items could be refreshed or updated periodically. Host software can track changes in the host's file structure and initiate the synchronization with the appliance. In this approach, all menu items could be updated without user involvement or selections.

### CONCLUSION

Embodiments of the present invention enable menu information to be easily exchanged among processor-based devices, including processor-based devices having disparate capabilities. By providing for a division of responsibility of tasks, a host having a relatively large resource capability can support a menu structure or file structure of media files on an appliance having a relatively small resource capability. The apparent file structure of the appliance can be similar or identical, if desired, to that of the host, thus facilitating the appliance user's ease of use and enjoyment of the appliance. The appliance can have a multi-level file structure that reflects the host file structure. The appliance user can arrange files, folders, and other organizational elements in any manner that reflects his or her personal usage pattern.

In some embodiments, menus can be updated to an appliance without active user involvement, while optionally permitting a user to control the menu update process to any desired extent.

In addition, in some embodiments, the appliance menu can automatically appear in a desired natural language, such as the language used on the host, or in a preferred language that is part of the appliance specification that is registered with a host.

By using the software-implemented methods of embodiments of the present invention, many types of processor-based devices such as, but not limited to, digital appliances and DPFs become more commercially attractive.

As shown herein, the present invention can be implemented in a number of different embodiments, including various methods, a host, an appliance, and an article comprising a machine-accessible medium having associated instructions. Other embodiments will be readily apparent to those of ordinary skill in the art. The elements, algorithms, and sequence of operations can all be varied to suit particular requirements.

In view of the disclosure herein, it will be apparent to those skilled in the art how to write suitable software routines that implement the functions, features, and GUIs discussed above.

The illustrated architectures of processor-based appliances and hosts described herein are only examples of possible architectures. Embodiments of the present invention are in no way limited to any particular architecture for the processor-based appliances or hosts.

FIGS. 1 through 7, 17, and 19-25 and are merely representational and are not drawn to scale. Certain proportions thereof may be exaggerated, while others may be minimized. FIGS. 1-26 illustrate various embodiments of the invention that can be understood and appropriately carried out by those of ordinary skill in the art.

Although specific embodiments have been illustrated and described herein, it will be appreciated by those of ordinary skill in the art that any arrangement or process that is calculated to achieve the same purpose may be substituted for the specific embodiments shown. This application covers any adaptations or variations of embodiments of the present invention. Therefore, it is manifestly intended that embodiments of this invention be limited only by the claims and the equivalents thereof.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

What is claimed is:

1. A method comprising:
storing a plurality of digital media files in a file structure on a host; and
wirelessly communicating information regarding the file structure to a processor-based appliance to render the information into one of a visual form and an audio form.

2. The method recited in claim 1 wherein, in communicating, the information comprises a list of item identifiers.

3. The method recited in claim 2 and further comprising:
examining the file structure to generate the list of item identifiers.

4. The method recited in claim 2 wherein the item identifiers are associated with corresponding files and file storage units of the file structure.

5. The method recited in claim 1, wherein the file structure has a hierarchy, and further comprising:
from the information, generating a subset of the file structure on the processor-based appliance, the hierarchy of the subset being substantially identical to a portion of the file structure hierarchy.

6. The method recited in claim 1 and further comprising:
receiving a request from the processor-based appliance for the information; and
wherein communicating is performed in response to receiving.

7. The method recited in claim 1 and further comprising:
detecting a condition; and
wherein communicating is performed in response to detecting.

8. The method recited in claim 7 wherein the condition comprises one of a registration by the processor-based appliance, the expiration of a time period, and a change in the file structure.

9. The method recited in claim 8 wherein the change comprises one of an addition to the file structure, a deletion from the file structure, a regrouping in the file structure, and a renaming in the file structure.

10. The method recited in claim 1 wherein, in communicating, the information comprises a plurality of menu items.

11. The method recited in claim 10 wherein the plurality of menu items are to designate one of a software application to be installed on the processor-based appliance, a specific processor-based appliance function, a buddy list, a picture file, a video file, and an audio file.

12. The method recited in claim 1 wherein, in communicating, the information is in a format supported by the processor-based appliance.

13. The method recited in claim 1 wherein, in communicating, the information comprises a set of data to enable the processor-based appliance to render the information with preferred characteristics.

14. The method recited in claim 1 wherein storing further comprises storing at least one characteristic of the processor-based appliance.

15. The method recited in claim 14 wherein, in storing, the characteristic comprises a language identifier, and wherein, in communicating, the information is communicated in a language corresponding to the language identifier.

16. A method comprising:
a processor-based appliance wirelessly receiving a portion of a file structure of a host; and
the processor-based appliance rendering the portion of the file structure into one of a visual form and an audio form.

17. The method recited in claim 16 wherein, in receiving, the portion of the file structure has a hierarchy comprising at least an upper level and a lower level, and the method further comprises:
the processor-based appliance wirelessly transmitting a selection from the hierarchy.

18. The method recited in claim 17 wherein, in transmitting, the selection is one of an item from the upper level and an item from the lower level.

19. The method recited in claim 18 and further comprising:
the processor-based appliance wirelessly receiving the item from the host; and
the processor-based appliance rendering the item into one of a visual form and an audio form.

20. The method recited in claim 19,
wherein the processor-based appliance comprises a digital picture frame (DPF) having a display;
wherein the item comprises a digital photograph; and
wherein, in rendering, the DPF displays the digital photograph on the display.

21. The method recited in claim 16 wherein, in receiving, the portion of the file structure has a hierarchy comprising at least an upper level of folders and a lower level of folders, and the method further comprises:
the processor-based appliance wirelessly transmitting a selection from the hierarchy.

22. The method recited in claim 21 wherein, in transmitting, the selection comprises one of an identifier of a folder from the upper level and an identifier of a folder from the lower level.

23. The method recited in claim 22 and further comprising:
wirelessly receiving an abstraction of the folder from the host; and
rendering the abstraction into one of a visual form and an audio form.

24. The method recited in claim 23,
wherein the processor-based appliance comprises a digital picture frame (DPF) having a display;
wherein the abstraction comprises an icon; and
wherein, in rendering, the DPF displays the icon on the display.

25. The method recited in claim 16 wherein, in receiving, the portion comprises a set of data to enable the processor-based appliance to render the portion with a preferred sequence and with preferred characteristics.

26. The method recited in claim 25 wherein, in rendering, the processor-based appliance renders the portion according to the preferred sequence and characteristics.

27. A method comprising:
wirelessly receiving a registration request from a processor-based appliance, the registration request comprising an indicator of content data types supported by the processor-based appliance; and
wirelessly transmitting a registration acknowledgement to the processor-based appliance.

28. The method recited in claim 27 and further comprising:
before receiving, wirelessly initiating the registration request by the processor-based appliance.

29. The method recited in claim 27 wherein, in receiving, the registration request further comprises a unique identifier for the processor-based appliance.

30. The method recited in claim 29 wherein the unique identifier comprises a user-assigned name.

31. The method recited in claim 27 wherein, in receiving, the registration request further comprises an indication of storage capacity of the processor-based appliance.

32. The method recited in claim 27 wherein, in receiving, the registration request further comprises information concerning file formats supported by the processor-based appliance.

33. The method recited in claim 27 wherein, in receiving, the registration request further comprises at least one hardware support descriptor for the processor-based appliance.

34. The method recited in claim 27 wherein, in receiving, the registration request further comprises at least one display characteristic for the processor-based appliance.

35. The method recited in claim 34 wherein the at least one display characteristic is from the group consisting of pixel format, number of displayable pixels, data bit depth, gamma, color space, and color gamut.

36. The method recited in claim 27 wherein, in receiving, the registration request further comprises at least one audio playback characteristic for the processor-based appliance.

37. The method recited in claim 36 wherein the at least one audio playback characteristic is from the group consisting of audio data bit rate and audio data bit depth.

38. The method recited in claim 27 wherein, in receiving, the registration request further comprises a language identifier for the processor-based appliance.

39. The method recited in claim 38 and further comprising:
retrieving a menu set corresponding to the language identifier.

40. The method recited in claim 39 and further comprising:
transmitting the menu set to the processor-based appliance.

41. The method recited in claim 27 and further comprising:
wirelessly transmitting a list of data item identifiers to the processor-based appliance.

42. The method recited in claim 27 and further comprising:
wirelessly transmitting a menu item to the processor-based appliance.

43. The method recited in claim 27 and further comprising:
wirelessly transmitting a support item to the processor-based appliance, wherein the support item comprises software to enable the processor-based appliance to support at least one data type and format that the processor-based appliance did not previously support.

44. The method recited in claim 27 and further comprising:
wirelessly transmitting a support item to the processor-based appliance, wherein the support item comprises at least one menu item denoting a processor-based appliance function that the processor-based appliance did not previously have.

45. The method recited in claim 27 and further comprising:
wirelessly transmitting a support item to the processor-based appliance, wherein the support item comprises at least one menu item denoting a buddy list that the processor-based appliance did not previously have.

46. The method recited in claim 27 and further comprising:
wirelessly transmitting a support item to the processor-based appliance, wherein the support item comprises at least one menu item that the processor-based appliance did not previously have, and that denotes an action upon data items at the host.

47. A host comprising:
a memory to store a plurality of digital media files arranged in a file structure, and to further store program instructions;
a processor coupled to the memory to execute ones of the program instructions; and
a transceiver coupled to the processor to wirelessly communicate information regarding the file structure in accordance with ones of the program instructions.

48. The host recited in claim 47, wherein the memory is further to store a plurality of menu items each representative of a portion of the file structure, and wherein the transceiver is to wirelessly communicate at least one of the plurality of menu items.

49. The host recited in claim 47, wherein the transceiver is to wirelessly communicate the information to a processor-based appliance.

50. The host recited in claim 49, wherein the processor-based appliance comprises one of a digital picture frame, an Internet appliance, a personal digital assistant, a cellular telephone, a pager, an audio reproduction device, an electronic book, a chat pad, and a hand-held computer.

51. The host recited in claim 47 wherein the transceiver is further to wirelessly receive a request from a processor-based appliance for the information.

52. The host recited in claim 47, wherein the memory is further to store one or more conditions, and wherein information is communicated upon the occurrence of at least one of the conditions.

53. The host recited in claim 52, wherein the one or more conditions comprise one of a registration with the host by a processor-based appliance, the expiration of a time period, and a change in the file structure.

54. The host recited in claim 53 wherein the change comprises one of an addition to the file structure, a deletion from the file structure, a regrouping in the file structure, and a renaming in the file structure.

55. An appliance comprising:
a memory to store a plurality of menu items, and to further store program instructions;
a processor coupled to the memory to execute ones of the program instructions;
a transceiver coupled to the processor to wirelessly receive from a host, in accordance with ones of the program instructions, the plurality of menu items; and
a display coupled to the processor to display one or more of the plurality of menu items in accordance with ones of the program instructions.

56. The appliance recited in claim 55, wherein the plurality of menu items forms a hierarchy that is substantially identical in the memory and in the host.

57. The appliance recited in claim 55, wherein the plurality of menu items comprises a list of item identifiers.

58. The appliance recited in claim 55, wherein the transceiver is to wirelessly communicate bi-directionally with the host, the appliance further comprising:
a user interface coupled to the processor and to the transceiver, to receive a user selection of one of a menu item, a registration request, and an update time period, and to cause the transceiver to wirelessly transmit the user selection to the host.

59. The appliance recited in claim 58, wherein the transceiver is to wirelessly receive at least one new menu item from the host, in response to the user selection.

60. The appliance recited in claim 59, wherein the plurality of menu items forms a hierarchy comprising at least two levels, and wherein the at least one new menu item is from a different level than the one or more of the plurality of menu items.

61. An article comprising a machine-accessible medium having associated instructions, wherein the instructions, when accessed, result in a machine performing:
wirelessly receiving a portion of a file structure of a host;
rendering the portion of the file structure into one of a visual form and an audio form;
wirelessly receiving a user selection comprising a menu item from the rendered portion of the file structure; and
wirelessly transmitting the menu item to the host.

62. The article recited in claim 61 wherein the instructions, when accessed by the machine, result in the machine performing:
wirelessly receiving the portion of the file structure of the host in a hierarchical organization that is substantially identical in the machine and in the host.

63. The article recited in claim 61 wherein the instructions, when accessed by the machine, result in the machine performing:
wirelessly receiving at least one new menu item from the host, in response to wirelessly transmitting the menu item to the host.
